(19) United States
(12) Patent Application Publication
(10) Pub. No.: US 2019/0185333 A1
(43) Pub. Date: Jun. 20, 2019

(54) HETEROGENEOUS CATALYSTS/PROCESS BASED ON SUPPORTED/GRAFTED TRANSITION METAL HYDRIDES FOR AMMONIA FORMATION FROM NITROGEN AND HYDROGEN

(71) Applicant: SABIC Global Technologies B.V., Bergen op Zoom (NL)

(72) Inventors: Jean Marie Basset, Thuwal (SA); Janet Chakkamadathil Mohandas, Thuwal (SA); Balamurugan Vidjayacoumar, Thuwal (SA); Khalid Albahily, Thuwal (SA); Manoja Samantaray, Thuwal (SA)

(21) Appl. No.: 16/325,830

(22) PCT Filed: Aug. 9, 2017
(86) PCT No.: PCT/IB2017/054866

§ 371 Date: Feb. 15, 2019

Related U.S. Application Data
(60) Provisional application No. 62/376,015, filed on Aug. 17, 2016.

(51) Int. Cl. C01C 1/04; B01J 31/12; B01J 21/08

(52) U.S. Cl. CPC C01C 1/0411; B01J 21/08; B01J 31/121

(57) ABSTRACT

Disclosed is a catalyst and process for producing ammonia (NH₃). The process includes contacting a gaseous feed mixture comprising nitrogen (N₂) and hydrogen (H₂) with a metal hydride material under reaction conditions sufficient to produce a product stream comprising NH₃.

### CROSS REFERENCE TO RELATED APPLICATIONS

This application claims the benefit of priority of U.S. Provisional Patent Application No. 62/376,015 filed Aug. 17, 2016, which is hereby incorporated by reference in its entirety.

### BACKGROUND OF THE INVENTION

### A. Field of the Invention

The invention generally concerns a process for producing ammonia (NH₃). More particularly, the process includes contacting a gaseous feed mixture that includes nitrogen (N₂) and hydrogen (H₂) with a metal hydride material under reaction conditions sufficient to produce a NH₃ containing product stream.

### B. Description of Related Art

Nitrogen fixation in any form is essential for the production of many industrially important chemicals. Direct artificial nitrogen fixation to ammonia can be challenging as the dinitrogen triple bond is not easily activated for reduction. Commerical production of ammonia includes the Haber-Bosch process. This process uses a heterogeneous multipromoted iron (Fe) catalyst supported on Al₂O₃ under high temperatures (350-550° C.) and pressures (150-350 atm). Due to the extreme conditions of the process, a significant amount of energy is required to produce the present gross production of 10⁸ tons of ammonia annually.

Homogeneous catalysis to produce ammonia has been investigated. By way of example, Schrock et al. Science 2003, 301, pp. 76-78 describes a Mo complex that can catalytically transform dinitrogen to ammonia with a turn-over-number (TON) of 6 under ambient conditions. This process suffers from practical utility due to the complexity of the process.

Cleavage of the dinitrogen bond to produce oraganometallic nitrogen complexes has been described. By way of example, Avenier et al. (Science 2007, 317, pp. 1056-1060) describes cleavage of N₂ at 250° C. and atmospheric pressure by H₂ on an isolated silica surface-supported organometallic hydride centers, leading to an organometallic amido imido complex. In yet another example, of dinitrogen cleavages, Jia et al. (Inorg. Chem. 2015, Vol. 54, pp. 11648-11659) describes the organometallic amino reaction products of organometallic hydride complexes with hydrazines. Neither of these references describe the production of ammonia from cleavage of N₂.

In view of above problems associated with alternative means of producing NH₃, new economical routes for the production of NH₃ to meet growing global demands are needed.

### SUMMARY OF THE INVENTION

A discovery has been made that provides a solution to the aforementioned problems and inefficiencies associated with production of ammonia (NH₃). The discovery is premised on the use of a metal hydride material to catalyze the reaction of nitrogen gas (N₂) with hydrogen gas (H₂) under reactions conditions sufficient to form NH₃. Specifically, the metal hydride material can be a heterogeneous active surface complex based on one or more transition metal (Columns 3-12 of the Period Table) hydrides grafted onto an oxide support, such as amorphous/crystalline silica (SiO₂). Notably, the reaction proceeds at a temperature from 15° C. to 260° C., 100° C. to 200° C., preferably 150° C. and a reaction pressure of atmospheric, or 0.1 MPa to 2 MPa, 1.0 MPa to 2.0 MPa, preferably 1.5 MPa. Without wishing to be limited by theory, it is believed that the current metal hydride material prepared from alkyl/alkylidiene precursors of the corresponding transition metals provide an elegant and efficient process to prepare NH₃. As illustrated in non-limiting embodiments and in the Examples, active surface metal hydride complexes based on titanium (Ti) and tantalum (Ta) supported on SiO₂ show high activity and high TON in the current process under mild reaction conditions (e.g., room temperature and low pressure).

In one particular aspect of the present invention, there is described a process for producing ammonia (NH₃). The process can include contacting a gaseous feed mixture containing nitrogen (N₂) and hydrogen (H₂) with a metal hydride material under reaction conditions sufficient to produce a product stream including NH₃. The metal hydride material can have the general formula:

[(R)ₓMH_{y}]

where M is a transition metal; R is a hydrocarbon, a substituted hydrocarbon, or any combination thereof, preferably, an alkyl group, a substituted alkyl group, or any combination thereof; 0≤x; 1≤y; and x+y is equal to the valence of M. The reaction conditions of the process can include a temperature from 15° C. to 260° C., 100° C. to 200° C., preferably 150° C. and a reaction pressure of atmospheric, or 0.1 MPa to 2 Mpa, 1.0 MPa to 2.0 MPa, preferably 1.5 MPa. In one aspect, a volume ratio of N₂ to H₂ (N₂:H₂) in the process can be 1:1 to 1:4, preferably 1:3. In another aspect, the metal hydride material can include a support, and the support can inlcude silica (SiO₂), alumina (Al₂O₃), magnesia (MgO), titania (TiO₂), chromia (Cr₂O₃), zeolites, carbon nanotubes, carbon black, sulfides, nitrides, or combinations thereof. In some aspects, the support can be mesoporous SiO₂, fibrous SiO₂ (KCC-1-700), binuclear dehydroxylated SiO₂ (SiO₂-700), mononuclear dehydroxylated SiO₂, or any combination thereof. In particular instances, R of the metal hydride material in the process of the present invention can include 1 to 7 carbon atoms, preferably 1 to 5. By way of example, R can be a methyl group, ethyl group, propyl group, isopropyl group, n-butyl group, sec-butyl group, tert-butyl group, pentyl group, neopentyl, hexyl group, or combinations thereof. In some aspects, the metal hydride transition metal can be scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), a metal from the lanthanide series, lanthanum (La), cerium (Ce), a metal of the actinide series, thaallium (Th), or any alloy thereof. In a preferred aspect, the transition metal can be Ta, Ti, Zr, Hf, Mo, or W, preferably Ta or Ti. In one embodiment, the transition metal can be a supported Ta hydride material having a general structure of:

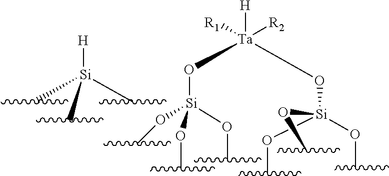

where R₁ and R₂ are each individually a hydrogen, a hydrocarbon, a substituted hydrocarbon group, or any combination thereof, preferably, an alkyl group, a substituted alkyl group, or any combination thereof. In one aspect, R₁ and R₂ are each hydrogen. In another aspect, the catalyst can be a supported Ti hydride having the general structure:

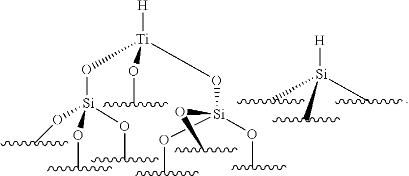

In another embodiment, the metal hydride material further includes a second metal hydride material having the general formula:

[(R₂)ₜM²Hᵤ]

where M² is a transition metal with the proviso that M and M² are different; R₂ is a hydrocarbon, a substituted hydrocarbon, or any combination thereof, preferably, an alkyl group, a substituted alkyl group, or any combination thereof; 0≤t; 1≤u; and t+u is equal to the valence of M². In some aspects, the metal hydride material can be in the form of a molecular complex, a molecular cluster, or a nanoparticle. In other aspects of the process, a portion of the ammonia can be adsorbed on the metal hydride material. In certain aspects, the process further includes collecting and storing the ammonia.

In another particular aspect of the present invention, there is described a metal hydride material capable of catalyzing the production of ammonia from nitrogen (N₂) and hydrogen (H₂), the metal hydride material having the general formula:

[(R)ₓMH_{y}]

where M is a transition metal; R is a hydrocarbon, a substituted hydrocarbon, or any combination thereof, preferably, an alkyl group, a substituted alkyl group, or any combination thereof; and 0≤x, 1≤y, and x+y is equal to the valence of M, wherein the metal hydride material is capable of catalyzing the production of ammonia from a mixture of nitrogen and hydrogen. In one aspect, the metal hydride material can include a support, preferably, dehydroxylated SiO₂.

In yet another particular aspect, there is described a method for preparing any one of the metal hydride materials of the present invention. The method can include (a) obtaining a solution comprising an hydrocarbon anion (R⁻); (b) reacting R⁻ with a transition metal (M) precursor to form a hydrocarbon metal (RₓM) material, where x is equal to the valence of M; and (c) treating the RₓM material with hydrogen (H₂) under conditions sufficient to form the catalyst having the general formula of:

[(R)ₓMH_{y}]

where M is a transition metal; R is a hydrocarbon, a substituted hydrocarbon, or any combination thereof, preferably, an alkyl group, a substituted alkyl group, or any combination thereof; and 0≤x, 1≤y, and x+y is equal to the valence of M; and (d) drying the material of step (c). In one aspect, the method further includes contacting RₓM with a support material prior to step (c). The support material may contain anchoring groups (i.e., hydroxyl, amine, etc.) that can bind to the metal (M). In some aspects, the conditions of step (c) can include a temperature of 60° C. to 160° C., preferably 70° C. to 150° C., and a hydrogen pressure of 0.05 MPa to 0.1 MPa, preferably 0.08 MPa. In other aspects, the method can further include: (i) obtaining a [(R₂)ₜM²Hᵤ] material, where M² is a transition metal R₂ is a hydrocarbon, a substituted hydrocarbon, or any combination thereof, preferably, an alkyl group, a substituted alkyl group, or any combination thereof; 0≤t, 1≤u, and t+u is equal to the valence of M²; and (ii) adding the material of step (i) to the compound of step (d). The material of step (i) can be supported.

In the context of the present invention, 24 embodiments are described. Embodiment 1 is a process for producing ammonia (NH₃) comprising contacting a gaseous feed mixture comprising nitrogen (N₂) and hydrogen (H₂) with a metal hydride material under reaction conditions sufficient to produce a product stream comprising NH₃, the metal hydride material having the general formula: [(R)ₓMH_{y}] where: M is a transition metal; R is a hydrocarbon, a substituted hydrocarbon, or any combination thereof, preferably, an alkyl group, a substituted alkyl group, or any combination thereof; 0≤x; 1≤y; and x+y is equal to the valence of M. Embodiment 2 is the process of embodiment 1, wherein the reaction conditions comprise a temperature from 15° C. to 260° C., 100° C. to 200° C., preferably 150° C. Embodiment 3 is the process of any one of embodiments 1 to 2, wherein the reactions conditions comprise a pressure of atmospheric pressure or 0.1 MPa to 2 MPa, 1 MPa to 2 MPa, preferably 1.5 MPa. Embodiment 4 is the process of any one of embodiments 1 to 3, wherein a volume ratio of N₂ to H₂ (N₂:H₂) is 1:1 to 1:4, preferably 1:3. Embodiment 5 is the process of any one of embodiments 1 to 4, wherein the metal hydride material comprises a support. Embodiment 6 is the process of embodiment 5, wherein the support comprises silica (SiO₂), alumina (Al₂O₃), magnesia (MgO), titania (TiO₂), chromia (Cr₂O₃), zeolites, carbon nanotubes, carbon black, sulfides, nitrides, or combinations thereof. Embodiment 7 is the process of embodiment 6, wherein the support is mesoporous SiO₂, fibrous SiO₂ (KCC-1-700), binuclear dehydroxylated SiO₂ (SiO₂-700), mononuclear dehydroxylated SiO₂, or any combination thereof. Embodiment 8 is the process of any one of embodiments 1 to 7, wherein R comprises 1 to 7 carbon atoms, preferably 1 to 5. Embodiment 9 is the process of embodiment 8, wherein R is a methyl group, ethyl group, propyl group, isopropyl group, n-butyl group, sec-butyl group, tert-butyl group, pentyl group, neopentyl, hexyl group, or combinations thereof. Embodiment 10 is the process of any one of embodiments 1 to 9, wherein the transition metal is scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), Lanthanide series, lanthanum (La), cerium (Ce), Actinide series, rutherfordium (Rf), dubnium (Db), seaborgium (Sg), bohrium (Bh), hassium (Hs), meitnerium (Mt), darmstadtium (Ds), roentgenium (Rg), or copernicum (Cn) or any alloy thereof. Embodiment 11 is the process of embodiment 10, wherein the transition metal is Ta, Ti, Zr, Hf, Mo, or W, preferably Ta or Ti. Embodiment 12 is the process of embodiment 11, wherein the transition metal is Ta, and metal hydride material has a general structure of:

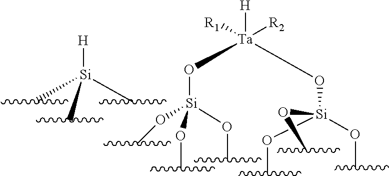

where R₁ and R₂ are each individually a hydrogen, a hydrocarbon, a substituted hydrocarbon group, or any combination thereof, preferably, an alkyl group, a substituted alkyl group, or any combination thereof. Embodiment 13 is the process of embodiment 12, wherein R₁ and R₂ are each hydrogen. Embodiment 14 is the process of embodiment 11, where the transition metal is Ti, and the metal hydride material has the general structure:

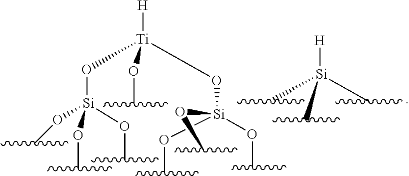

Embodiment 15 is the process of any one of embodiments 1 to 14, wherein the metal hydride material further comprises a second metal hydride material having the general formula: [(R₂)ₜM²Hᵤ] where: M² is a transition metal with the proviso that M and M² are different; R₂ is a hydrocarbon, a substituted hydrocarbon, or any combination thereof, preferably, an alkyl group, a substituted alkyl group, or any combination thereof; 0≤t; 1≤u; and t+u is equal to the valence of M². Embodiment 16 is the process of any one of embodiments 1 to 15, wherein the metal hydride material is in the form of a molecular complex, a molecular cluster, or a nanoparticle. Embodiment 17 is the process of any one of embodiments 1 to 16, wherein a portion of the ammonia is adsorbed on the metal hydride material. Embodiment 18 is the process of any one of embodiments 1 to 17, further comprising collecting the ammonia.

Embodiment 19 is a metal hydride material capable of catalyzing the production of ammonia from nitrogen (N₂) and hydrogen (H₂), the metal hydride material having the general formula: [(R)ₓMH_{y}] where: M is a transition metal; R is a hydrocarbon, a substituted hydrocarbon, or any combination thereof, preferably, an alkyl group, a substituted alkyl group, or any combination thereof; and 0≤x, 1≤y, and x+y is equal to the valence of M, wherein the metal hydride material is capable of catalyzing the production of ammonia from a mixture of nitrogen and hydrogen. Embodiment 20 is the metal hydride material of embodiment 19, wherein the metal hydride material comprises a support, preferably, dehydroxylated SiO₂.

Embodiment 21 is a method for preparing any one of the metal hydride materials of any one of the embodiments 19 to 20, the method comprising: (a) obtaining a solution comprising an hydrocarbon anion (R⁻); (b) reacting W with a transition metal (M) precursor to form a hydrocarbon metal (RₓM) material, where x is equal to the valence of M; and (c) treating the RₓM material with hydrogen (H₂) under conditions sufficient to form the catalyst having the general formula of: [(R)ₓMH_{y}] where: M is a transition metal; R is a hydrocarbon, a substituted hydrocarbon, or any combination thereof, preferably, an alkyl group, a substituted alkyl group, or any combination thereof; and 0≤x, 1≤y, and x+y is equal to the valence of M; and (d) drying the material of step (c). Embodiment 22 is the method of embodiment 21, further comprising contacting RₓM with a support material prior to step (c). Embodiment 23 is the method of any one of embodiments 21 to 22, wherein the conditions of step (c) comprise a temperature of 60° C. to 160° C., preferably 70° C. to 150° C., and a hydrogen pressure of 0.05 MPa to 0.1 MPa, preferably 0.08 MPa. Embodiment 24 is the method of any one of embodiments 21 to 23, further comprising: (i) obtaining a [(R₂)ₜM²Hᵤ] material, where: M² is a transition metal; R₂ is a hydrocarbon, a substituted hydrocarbon, or any combination thereof, preferably, an alkyl group, a substituted alkyl group, or any combination thereof; and 0≤t, 1≤u, and t+u is equal to the valence of M²; and (ii) adding the material of step (i) to the compound of step (d). Embodiment 24 is the method of emboidmnet 24, wherein the material of step (i) is supported.

The following includes definitions of various terms and phrases used throughout this specification.

The term “homogeneous” in the context of this invention means the catalyst is soluble (i.e., same phase as the reactants) in the reaction solution. In direct contrast, the term “heterogeneous” refers to the form of catalysis where the phase of the catalyst differs from that of the reactants.

The term “alkyl group” refers to a straight or branched chain alkyl moiety having 1 to 20 carbon atoms and includes, for example, methyl, ethyl, n-propyl, isopropyl, n-butyl, isobutyl, sec-butyl, tert-butyl, 1-pentyl, 2-pentyl, 3-pentyl, 3-methyl-1-butyl, 2-methyl-1-butyl, 2,2-dimethyl-1-propyl, 3-methyl-2-butyl, 2-methyl-2-butyl, 1-hexyl, 2-hexyl, 3-hexyl, 1-heptyl, 2-heptyl, 3-heptyl, 4-heptyl, 1-octyl, 2-oetyl, 3-oetyl, 4-octyl, 2-ethylhexyl, 1,1,3,3-tetramethylbutyl, nonyl, decyl, dodecyl, tetradecyl, hexadecyl, octadecyl, eicosyl, cyclohexyl, cyclopentyl, or benzyl.

The term “substituted alkyl group” means any of the aforementioned alkyl groups that are additionally substituted with one or more heteroatom, such as a halogen (F, Cl, Br, I), boron, oxygen, nitrogen, sulfur, silicon, etc. Without limitation, a substituted alkyl group can include alkoxy, which means straight or branched chain alkoxy having 1 to 10 carbon atoms, and includes, for example, methoxy, ethoxy, propoxy, isopropoxy, butoxy, isobutoxy, secondary butoxy, tertiary butoxy, pentyloxy, isopentyloxy, hexyloxy, heptyloxy, octyloxy, nonyloxy and decyloxy, haloalkyl, which means straight or alkyl having 1 to 8 carbon atoms which is substituted by at least one halogen, and includes, for example, chloromethyl, bromomethyl, fluoromethyl, iodomethyl, 2-chloroethyl, 2-bromoethyl, 2-fluoroethyl, 3-chloropropyl, 3-bromopropyl, 3-fluoropropyl, 4-chlorobutyl, 4-fluorobutyl, dichloromethyl, dibromomethyl, difluoromethyl, diiodomethyl, 2,2-dichloroethyl, 2,2-dibromoethyl, 2,2-difluoroethyl, 3,3-dichloropropyl, 3,3-difluoropropyl, 4,4-dichlorobutyl, 4,4-difluorobutyl, trichloromethyl, trifluoromethyl, 2,2,2-trifluoroethyl, 2,3,3-trifluoropropyl, 1,1,2,2-tetrafluoroethyl and 2,2,3,3-tetrafluoropropyl, or alkylamine, which includes mono- or di-substituted alkyl and/or substituted alkyl chains mentioned above attached to the nitrogen atom of the amine.

The term “catalyst” means a substance which alters the rate of a chemical reaction. “Catalytic” means having the properties of a catalyst.

The term “nanotube” means a tubular structure having at least one diameter on the order of nanometers (e.g., between about 1 and 1000 nanometers) and an aspect ratio preferably greater than 5:1. The “aspect ratio” of a nanotube is the ratio of the actual length (L) of the nantube to the diameter (D) of the nanotube.

“Nanoparticle” means a particle having at least one diameter on the order of nanometers (e.g., between about 1 and 1000 nanometers).

The “turn over number” or ON,” as used herein, means the number of moles of substrate that a mole of catalyst converts in the timeframe of the experiment or before being deactivated. TON is calculated as the number of moles of nitrogen (N₂), divided by the number of moles of metal hydride material unless otherwise indicated.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include to ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The terms “wt. %”, “vol. %”, or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The use of the words “a” or “an” when used in conjunction with any of the terms “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the methods and catalysts of the present invention are their abilities to producing NH₃ from N₂ and H₂.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 shows a schematic of a one reactor system to produce ammonia of the present invention.

FIG. 2 shows a reaction schematic for the formation of a supported metal hydride of the present invention ((≡Si—O)TiH_{y}) and its use to catalyze the formation of NH₃ from N₂ and H₂.

FIG. 3 shows the NMR spectrum of the [(≡Si—O)TiH_{y}] of the present invention.

FIG. 4 shows stepwise in-situ IR spectrums of [(≡Si—O)TiH_{y}] of the present invention during reaction with N₂ and H₂ under various heat treatment temperatures.

FIG. 5 shows the reaction schematic for the formation of [(≡Si—O)ₓTaH_{y}] of the present invention.

FIG. 6 shows the ¹H NMR spectrum of [(≡Si—O)ₓTaH_{y}] of the present invention.

FIG. 7 shows the ¹⁵N-MAS NMR spectrum of [(≡Si—O)ₓTaH_{y}] of the present invention after treatment with ¹⁵N₂ and H₂ at room temperature.

FIG. 8 shows ¹⁵N₂-¹H HETCOR NMR spectra of (A): [(≡Si—O)ₓTaH_{y}] of the present invention after reaction with ¹⁵N₂ and H₂ at 100° C. for 10 hours and (B): [(≡Si—O)ₓTaH_{y}] after reaction with ¹⁵NH₃ at room temperature.

FIG. 9 shows the IR difference spectra of [(≡Si—O)ₓTaH_{y}] of the present invention before and after reaction with N₂ and H₂ and the IR spectral features associated with various vibrations possible upon reaction with N₂ and H₂ or NH₃.

FIG. 10 shows a GC-MS chromatogram with corresponding SIM and M/Z pattern obtained from the gas phase analysis after reacting N₂ and H₂ in presence of [(≡Si—O)ₓTaH_{y}] of the present invention.

FIG. 11 shows stepwise in-situ IR spectrums of the reaction of [(≡SiO)ₓTaH_{y}]] of the present invention pellet (Ta Wt. %: 7.39) as prepared and after treatment with ¹⁴N₂ (0.2 bar) and H₂ (0.8 bar) at different temperatures ranging from room temperature to 100° C.

FIG. 12 shows dynamic reaction activities of [(≡Si—O)ₓTaH_{y}] of the present invention on different supports for (a) NH₃ formed vs. temperature and (b) TON vs. time.

FIG. 13 shows stepwise in-situ IR spectrums of the reaction of bimetallic [(≡SiO)TiH_{y}] [(≡SiO)ₓWH_{y}] of the present invention with N₂ and H₂ at various temperatures.

FIG. 14 shows the stepwise in-situ IR spectrums of the reaction of [(≡Si—O)ₓZrH_{y}] of the present invention with N₂ and H₂ at various temperatures.

FIG. 15 shows the stepwise in-situ IR spectrums of the reaction of [(≡Si—O)xHfH_{y}] of the present invention with N₂ and H₂ at various temperatures.

FIG. 16 shows the stepwise in-situ IR spectrums of the reaction of [(≡Si—O)ₓMoH_{y}] of the present invention with N₂ and H₂ at various temperatures.

FIG. 17 shows the stepwise in-situ IR spectrums of the reaction of [(≡Si—O)ₓWH_{y}] of the present invention with N₂ and H₂ at various temperatures.

### DETAILED DESCRIPTION OF THE INVENTION

A discovery has been made that provides a solution to the aforementioned problems and inefficiencies associated with the generation of ammonia (NH₃). The discovery is based on the reaction of nitrogen (N₂) and hydrogen (H₂) with a supported heterogeneous metal hydride complex under reaction conditions to produce ammonia. This discovery provides an elegant and economical alternative methodology to the current commercial processes (e.g., Haber-Bosch process).

These and other non-limiting aspects of the present invention are discussed in further detail in the following sections.

### A. Metal Hydride Material

In one embodiment, the metal hydride material of the present invention has the general formula:

[(R)ₓMH_{y}]

where M is a transition metal; R is a hydrocarbon, a substituted hydrocarbon, or any combination thereof, preferably, an alkyl group, a substituted alkyl group, or any combination thereof; 0≤x; 1≤y; and x+y is equal to the valence of M. When R is an alkyl group, the alkyl group can be a straight or branched chain alkyl group having 1 to 20 carbon atoms. For example, the alkyl group can be methyl, ethyl, n-propyl, isopropyl, n-butyl, isobutyl, secbutyl, tert-butyl, 1-pentyl, 2-pentyl, 3-pentyl, 3-methyl-1-butyl, 2-methyl-1-butyl, 2,2-dimethyl-1-propyl, 3-methyl-2-butyl, 2-methyl-2-butyl, 1-hexyl, 2-hexyl, 3-hexyl, 1-heptyl, 2-heptyl, 3-heptyl, 4-heptyl, 1-octyl, 2-octyl, 3-octyl, 4-octyl, 2-ethylhexyl, 1,1,3,3-tetramethylbutyl, nonyl, decyl, dodecyl, tetradecyl, hexadecyl, octadecyl, eicosyl, cyclohexyl, cyclopentyl, or benzyl. When R is a substituted alkyl group, the substituted alkyl group can include any of the aforementioned alkyl groups that are additionally substituted with one or more heteroatom, such as a halogen (F, Cl, Br, I), boron, oxygen, nitrogen, sulfur, silicon, etc. Without limitation, a substituted alkyl group can include alkoxy, which means straight or branched chain alkoxy having 1 to 10 carbon atoms, and includes, for example, methoxy, ethoxy, propoxy, isopropoxy, butoxy, isobutoxy, secondary butoxy, tertiary butoxy, pentyloxy, isopentyloxy, hexyloxy, heptyloxy, octyloxy, nonyloxy and decyloxy, haloalkyl, which means straight or alkyl having 1 to 8 carbon atoms which is substituted by at least one halogen, and includes, for example, chloromethyl, bromomethyl, fluoromethyl, iodomethyl, 2-chloroethyl, 2-bromoethyl, 2-fluoroethyl, 3-chloropropyl, 3-bromopropyl, 3-fluoropropyl, 4-chlorobutyl, 4-fluorobutyl, dichloromethyl, dibromomethyl, difluoromethyl, diiodomethyl, 2,2-dichloroethyl, 2,2-dibromoethyl, 2,2-difluoroethyl, 3,3-dichloropropyl, 3,3-difluoropropyl, 4,4-dichlorobutyl, 4,4-difluorobutyl, trichloromethyl, trifluoromethyl, 2,2,2-trifluoroethyl, 2,3,3-trifluoropropyl, 1,1,2,2-tetrafluoroethyl and 2,2,3,3-tetrafluoropropyl, or alkylamine, which includes mono- or di-substituted alkyl and/or substituted alkyl chains mentioned above attached to the nitrogen atom of the amine. In a preferred embodiment, R includes 1 to 7 carbon atoms, preferably 1 to 5. R can be a methyl group, ethyl group, propyl group, isopropyl group, n-butyl group, sec-butyl group, tert-butyl group, pentyl group, neopentyl, hexyl group, or combinations thereof. In certain embodiments, R can include a mixture of stereoisomers, such as enantiomers and diastereomers. When M is a transition metal, the transition metal can be a metal from Columns 4-12 of the Periodic Table. Non-limiting examples of transition metals include Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, lanthanide series (e.g., La and Ce), actinide series, (e.g., Th). In a preferred embodiment, the transition metal is a Column 4-8 transition metal, such as Ta, Ti, Zr, Hf, Mo, or W, preferably Ta or Ti. Non-limiting commercial sources of transition metals include Sigma-Aldrich® MO, USA.

In another embodiment, the metal hydride material can include a support. The support material or a carrier can be porous and have a high surface area. In some embodiments, the support is active (i.e., has catalytic activity). In other aspects, the support is inactive (i.e., non-catalytic). The support can be an inorganic oxide. In some embodiments, the support can include an inorganic oxide, alpha, beta or theta alumina (Al₂O₃), activated Al₂O₃, silicon dioxide (SiO₂), titanium dioxide (TiO₂), magnesium oxide (MgO), calcium oxide (CaO), strontium oxide (SrO), zirconium oxide (ZrO₂), chromium oxides (CrO, CrO₂, CrO₃, CrO₅, Cr₂O₃, or mixed valence species, such Cr₈O₂ᵢ), zinc oxide (ZnO), lithium aluminum oxide (LiAlO₂), magnesium aluminum oxide (MgAlO₄), manganese oxides (MnO, MnO₂, Mn₂O₄), lantheum oxide (La₂O₃), activated carbon, silica gel, zeolites, activated clays, silicon carbide (SiC), diatomaceous earth, magnesia, aluminosilicates, calcium aluminate, carbon nanotubes (mono wall or multi walled), carbon black, sulfides, nitrides, mesoporus materials (i.e., MCM 41, SBA-15, and high surface area mesoporous supports), or combinations thereof. In certain aspects, the support can be mesoporous SiO₂, fibrous SiO₂ (KCC-1-700), binuclear dehydroxylated SiO₂ (SiO₂-700), mononuclear dehydroxylated SiO₂, or any combination thereof. In other embodiments, the support material can include a carbonate (e.g., MgCO₃, CaCO₃, SrCO₃, BaCO₃, Y₂(CO₃)₃, La₂(CO₃)₃, or combination thereof).

The amount of metal hydride material on the support material depends, inter alia, on the catalytic activity of the catalyst. In some embodiments, the amount of metal hydride material present on the support ranges from 1 to 100 parts by weight of metal hydride material per 100 parts by weight of support, 0.5 to 50 parts by weight of metal hydride material per 100 parts by weight of support, from 1 to 30 parts by weight of metal hydride material per 100 parts by weight of support, from 1 to 20 parts by weight of metal hydride material per 100 parts by weight of support, or from 5 to 10 parts by weight of metal hydride material per 100 parts by weight of support. In other embodiments, the amount of metal hydride material present on the support is from 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 parts of metal hydride material per 100 parts by weight of support.

In some embodiments, the catalyst can be supported on a dehydroxylated silica material. The structure of the supported structure can include O-SupportH moieties, Support-O-MHR moieties, Support-O-MH moieties, or any combination thereof as shown in the representative structures below using SiO₂ as the support material, where the squiggly line represents the surface of the support material. Although Si is shown it should be understood that other supports can produce these general active species.

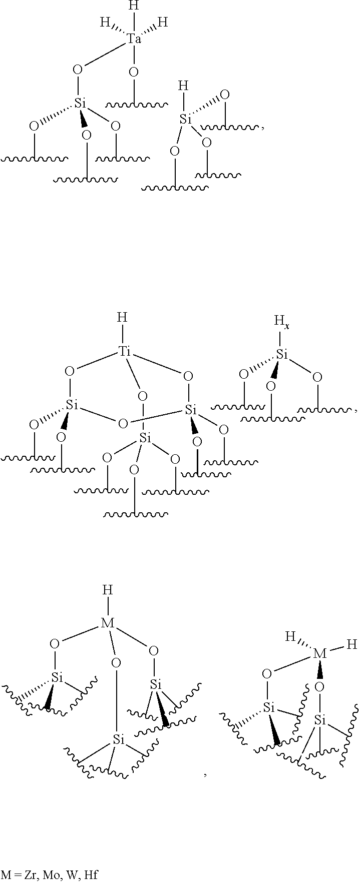

Non-limiting examples of a metal hydride supported on dehydroxlyated silica are Ta and Ti hydride supported materials. The supported Ta hydride material can have a general structure:

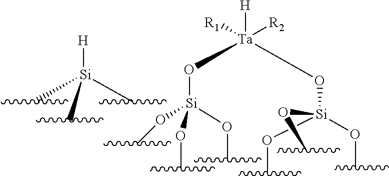

where R₁ and R₂ are each individually a hydrogen, a hydrocarbon, a substituted hydrocarbon group, or any combination thereof, preferably, an alkyl group, a substituted alkyl group, or any combination thereof. When R₁ and R₂ are an alkyl group, the alkyl group can be any of the alkyl groups previously mentioned. When R₁ and R₂ are a substituted alkyl group, the substituted alkyl group can be any of the substituted alkyl groups previously mentioned. Preferably, R₁ and R₂ are each hydrogen. The supported Ti hydride material can have a general structure:

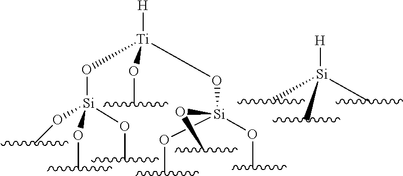

The metal hydride material can include more than one hydride material or more than one metal. By way of example, the metal hydride can include a second metal hydride material having the general formula:

[(R₂)ₜM²Hᵤ]

where M² is a transition metal with the proviso that M and M² are different; R₂ is a hydrocarbon, a substituted hydrocarbon, or any combination thereof, preferably, an alkyl group, a substituted alkyl group, or any combination thereof; 0≤t; 1≤u; and t+u is equal to the valence of M². When R₂ is an alkyl group, the alkyl group can be any of the alkyl groups previously mentioned. When R₂ is a substituted alkyl group, the substituted alkyl group can be any of the substituted alkyl groups previously mentioned. Any of the described metal hydride materials of the current invention may also be in the form of a molecular complex, a molecular cluster, or a nanoparticle. The overall formula of the mixed hydride can be represented by [(R)ₓMH_{y}] [(R₂)ₜM²Hᵤ], where R, R₂, M, M², H_{y}, and Hᵤ are defined above. Non-limiting examples of a bimetallic metal hydride material is a silica supported titanium tungsten hydride (e.g., [(R)ₓSiH_{y}]/SiO₂ [(R₂)ₜWHᵤ/SiO₂]), which when treated with hydrogen can form [≡SiH_{y}]/SiO₂ [WHᵤ/SiO₂]).

### B. Methods of Preparation

The materials used to make the unsupported and supported metal hydride materials of the present invention can be purchased or made by processes known to those of ordinary skill in the art (e.g., solution chemistry, schlenk filtration, precipitation/co-precipitation, sol-gel, templates/surface deriv ati zed synthesis, solid-state synthesis, microemul si on technique, solvothermal, sonochemical, etc.). In general aspects, unsupported and supported active metal hydride species (i.e. monometallic, bimetallic, or cluster hydrides) can be prepared by hydrogenating different precursors of transition metals (i.e., Columns 3-12 of the Periodic Table) containing various ligands, such as alkyl, alkylidyne, nitrides, hydrides, etc.

1. Preparation of Metal Hydride Material

In one embodiment, a method to prepare the metal hydride material of the current invention is described. A first step of the method includes obtaining a solution comprising an hydrocarbon salt that include a hydrocarbon anion (R⁻) and metal cation. The hydrocarbon anion (R⁻) can be alkyl group or a substituted alkyl group including any of the alkyl groups or substituted alkyl groups previously mentioned. The cation can be lithium, sodium, potassium, magnesium, zinc, etc. Non-limiting examples of hydrocarbon salts include alkyllithium, alkylmagnesium halide, dialkylmagnesium, alkylzinc halide, dialkylzinc, etc., which can be purchased from a commercial source or prepared by known methods in the art under anhydrous conditions. In a non-limiting example, the hydrocarbon anion (R⁻) is neopentyl lithium prepared by reacting neopentyl chloride and finely chopped Li wire in hexane. In step 2 of the method, the hydrocarbon anion (R⁻) is reacted with a transition metal (M) precursor to form a hydrocarbon metal (RₓM) material, where x is equal to the valence of M. In the reaction of a hydrocarbon anion (R⁻) with a transition metal (M) precursor, leaving groups attached to the metal (M) precursor are displaced by the hydrocarbon anion (R⁻) to form a carbon metal bond. The process can be highly exothermic so the reaction can be performed at low temperature or under cryogenic conditions. The leaving group attached to the metal precursor can be a charged or uncharged atom (or group of atoms) that can be displaced as a stable species. Examples of leaving groups include, but are not limited to, halogen (e.g., Cl, Br, I), azide (N₃), thiocyanate (SCN), cyanate (CN), alkoxide (OR), acetate (OAc), trifluoroacetate (CO₂CF₃), amine (NR₂), and sulfonate groups (e.g., OSO₂—R, wherein R can be a C₁₋₁₀ alkyl group or a C₆₋₁₄ aryl group each optionally substituted with 1-4 groups independently selected from a C₁₋₁₀ alkyl group and an electronwithdrawing group) such as tosylate (toluenesulfonate, OTs), mesylate (methanesulfonate, OMs), brosylate (p-bromobenzenesulfonate, OBs), nosylate (4-nitrobenzenesulfonate, ONs), and triflate (trifluoromethanesulfonate, OTf). In a non-limited example, a solution of Ti(OEt)₄ in pentane was cooled to −78° C. in a dry ice/acetone bath and neopentyllithium in pentane was added. The reaction mixture was stirred for 1.5 hours at −78° C. and then warmed to room temperature and stirred for a further 3-6 hours. The pentane can then be removed to obtain crude tetraneopentyltitanium (TiNp₄) as a brown solid which can be further purified by sublimation. In step 3 of the method, the RₓM material is treated with hydrogen (H₂) under conditions sufficient to form the catalyst having the general formula of:

[(R)ₓMH_{y}]

where M is a transition metal; R is a hydrocarbon, a substituted hydrocarbon, or any combination thereof, preferably, an alkyl group, a substituted alkyl group, or any combination thereof; and 0≤x, 1≤y, and x+y is equal to the valence of M. When R is an alkyl group, the alkyl group can be any of the alkyl groups previously mentioned. When R is a substituted alkyl group, the substituted alkyl group can be any of the substituted alkyl groups previously mentioned. Step 4 includes drying the material of step 3. In a non-limiting example, a method to prepare the active metal hydride material includes treating the RₓM material with hydrogen (H₂). The exemplary method includes mixing anhydrous H₂ and the unactivated metal hydride material and heating to 100-150° C. for 15 hours in a glass reactor tube in the dark to give the active metal hydride material that can be confirmed by spectrometric methods (e.g., NMR).

2. Preparation of Supported Metal Hydride Material

In another embodiment, a method to prepare the supported metal hydride material of the current invention is described. In one aspect, the method includes first contacting RₓM with a support material having active anionic sites prior to step 3 above. The support material can be silica, silica-Al₂O₃, partially dehydroxylated silica, mesoporous, microporous silicates, zeolites and other acidic/basic/amphoteric or porous/non-porous/amorphous/crystalline supports etc. The support material may contain an anchoring moiety or group that can bind with the metal directly or indirectly. Preferably the anchoring group is an anionic group containing hydroxyl, amine, carboxylate, thiol, etc. functionality. In a particular embodiment the support is dehydroxylated silica and RₓM is grafted to the support material. In a non-limiting example, the method of grafting the RₓM with a support material includes mixing RₓM in a hydrocarbon solvent (e.g., pentane) with a support material (e.g. SiO₂-(700)) at 25° C. and stirring for a desired amount of time (e.g., 2 hours) under an inert atmosphere to form the supported RₓM material (e.g., [SiO-MRₓ]). The supported RₓM material can be isolated from the solution using known separation methods (e.g., gravity filtration, centrifugation, vacuum filtration, etc.). After isolation, the solid can be washed with additional solvent (e.g. 1, 2, 3, 4, or 5 times with pentane) and dried under vacuum (e.g., 15 min under vacuum at 25° C.). The dried supported RₓM material can then be hydrogenated as described in step 3 above to form the supported metal hydride catalyst.

In some aspects, the conditions of step 3 above where a RₓM material or a supported RₓM material (i.e. [≡SiO-MRₓ]) is treated with hydrogen (H₂) under conditions sufficient to form an unsupported or supported active metal hydride catalyst can include a temperature of 60° C. to 160° C. and all temperatures there between (e.g., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 155° C., 156° C., 157° C., 158° C., or 159° C.), preferably 70° C. to 150° C. and a hydrogen pressure of 0.05 MPa to 0.1 MPa and all pressures there between (e.g., 0.06 MPa, 0.07 MPa, 0.08 MPa, or 0.09 MPa), preferably 0.08 MPa. In some embodiments, steps 1 through 4 are performed in the absence of light, or substantially no light, to inhibit photodegradation or photoactivation of the material. In a non-limiting example, a method to prepare the supported active metal hydride material includes mixing anhydrous H₂ and the supported unactivated metal hydride material and heating to 100-150° C. at a pressure of 0.08 MPa for 15 hours in the dark to give the active metal hydride material that can be confirmed by spectrometric methods (e.g., NMR).

3. Preparation of Bimetallic Hydride Material

In other aspects, the method can further include: (i) obtaining a [(R₂)ₜM²Hᵤ] material, where M² is a transition metal, R₂ is a hydrocarbon, a substituted hydrocarbon, or any combination thereof, preferably, an alkyl group, a substituted alkyl group, or any combination thereof; and 0≤t, 1≤u, and t+u is equal to the valence of M²; and (ii) adding the material of step (i) to the compound of step (d). When R₂ is an alkyl group, the alkyl group can be any of the alkyl groups previously mentioned. When R₂ is a substituted alkyl group, the substituted alkyl group can be any of the substituted alkyl groups previously mentioned. The material of step (i) can be unsupported or supported. The metal hydride material can be a mixed with other unsupported and/or supported metal hydrides to form bimetallic or trimetallic metals with different transition metals in the form of a molecular complex, a molecular cluster or a nanoparticle. All combinations of mixtures of the unsupported and supported RₓM, RₓM², [(R)ₓMH_{y}], and [(R₂)ₜM²Hᵤ]s are envisioned in the current embodiments. The supported and unsupported metals included in a bimetallic hydride material can be hydrogenated separately then combined or combined then hydrogenated together. Optionally, only one of the metals included in the bimetallic hydride material can be active and the mixture can be optionally further hydrogenated. For example, RₓM or the dried solid powder obtained from the product of RₓM grafted with a supported metal material (e.g. [≡SiO-MRₓ]) can be mixed with [(R₂)ₜM²Hᵤ] in having a certain metal (M²/M) ratio and hydrogenated. The ratio of metals in the bimetallic metal hydride material (i.e., M²/M or M/M²) can be 0.05:1, 0.1:1, o.15:1, 0.2:1, 0.25:1, 0.3:1, 0.35:1, 0.4:1, 0.45:1, 0.5:1, 0.55:1, 0.6:1, 0.65:1, 0.7:1, 0.75:1, 0.8:1, 0.85:1, 0.9:1, 0.95:1, or 1:1. Preferably the ratio of metals is 1:1, 1:0.6 or 06:1. In a non-limiting example, [(≡Si—O)ₓM²H_{z}] can be mixed with [(≡Si—O)ₓMH_{y}] in pentane in 0.6:1 metal (M²/M) ratio. The powder obtained can then be hydrogenated under a H₂ contianing atmosphere at 100° C. for a desired amount of time (e.g., 15 hours) to obtain the corresponding bimetallic active hydride material (e.g., [(≡Si—O)ₓMH_{y}][(≡Si—O)ₓM²H_{z}].

The methods or the processes described herein can be carried out in solution using suitable solvents which can be readily selected by one skilled in the art of organic synthesis. Suitable solvents typically are substantially nonreactive with the reactants, intermediates, and/or products at the temperatures at which the reactions are carried out, e.g., temperatures that can range from the solvent's freezing temperature to the solvent's boiling temperature. A given reaction can be carried out in one solvent or a mixture of more than one solvent. Depending on the particular reaction step, suitable solvents for a particular reaction step can be selected. Examples of common organic solvents include petroleum ethers; acetonitrile; aromatic hydrocarbons such as benzene, toluene, xylene, and mesitylene; ketones such as acetone, and methyl ethyl ketone; ethers such as tetrahydrofuran, dioxane, bis(2-methoxyethyl)ether, diethyl ether, di-isopropyl ether, and t-butyl methyl ether; alcohols such as methanol, ethanol, butanol, and isopropyl alcohol; aliphatic hydrocarbons such as pentane, hexanes, heptane; esters such as methyl acetate, ethyl acetate, methyl formate, ethyl formate, isopropyl acetate, and butyl acetate; amides such as dimethylformamide and dimethylacetamide; sulfoxides such as dimethylsulfoxide; halogenated aliphatic and aromatic hydrocarbons such as dichloromethane, chloroform, ethylene chloride, chlorobenzene, dichlorobenzene, and trichlorobenzene; and cyclic solvents such as cyclopentanone, cyclohexanone, and 2-methypyrrolidone.

The methods or processes described herein can be monitored according to any suitable method known in the art. For example, product formation can be monitored by spectroscopic means, such as nuclear magnetic resonance spectroscopy (NMR, e.g., ¹H or ¹³C), infrared spectroscopy (IR), spectrophotometry (e.g., in-situ FT-IR or UV-visible), mass spectrometry (MS), or by chromatography such as high pressure liquid chromatograpy (HPLC), gas chromatography (GC), gel-permeation chromatography (GPC), or thin layer chromatography (TLC).

### C. Process to Make Ammonia

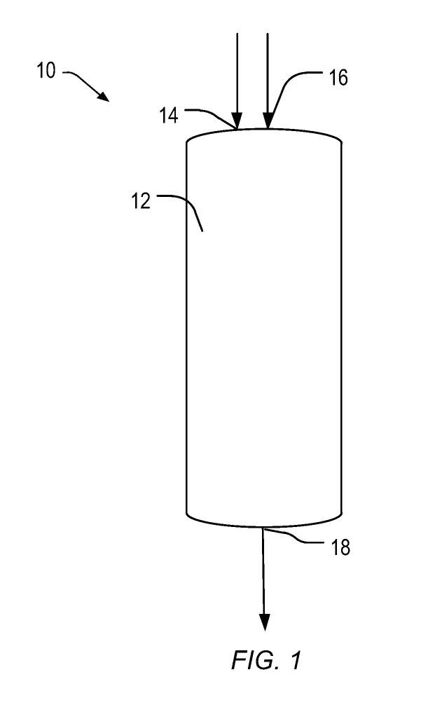

In yet another embodiment, the metal hydride material of the current invention is capable of catalyzing the production of ammonia from nitrogen (N₂) and hydrogen (H₂). In one aspect, the metal hydride material capable of catalyzing the production of ammonia includes a support, preferably, dehydroxylated SiO₂. Referring to FIG. 1, a method and system to prepare ammonia is described. In system 10, metal hydride material (e.g., [(R)ₓMH_{y}]) and optional solvents can be provided to a reactor unit 12 via solids inlet 14. Nitrogen (N₂) and hydrogen (H₂) and optional inert gases (e.g. argon) can be provided to reactor 12 via gas inlet 16. Although not shown, the reactor may have additional inlets for the introduction of gases that can be added to the reactor as mixtures or added separately and mixed within the reactor. In another aspect, the reaction can be carried out in a sealed reactor under inert atmosphere. The reactor can be made of materials that are chemically resistant to the reactants and products. The design and size of the reactor is sufficient to withstand the temperatures and pressures of the reaction. The reactor can include various automated and/or manual controllers, valves, heat exchangers, gauges, etc., for the operation of the reactor. The reactor can have insulation and/or heat exchangers to heat or cool the reactor as desired. Non-limiting examples of a heating/cooling source can be a temperature controlled furnace or an external, electrical heating block, heating coils, or a heat exchanger.

The reaction can be performed under inert conditions such that the concentration of oxygen (O₂) gas in the reaction is low or virtually absent in the reaction such that O₂ has a negligible effect on reaction performance (i.e. conversion, yield, efficiency, etc.). By way of example, gas inlet 26 may also be used for an evacuation outlet to remove and replace the atmosphere within the reactor with inert atmosphere or reactant gases in pump/purge cycles. Gas lines can be purged using dry N₂ to remove any traces of air and moisture. Reactant gases, N₂ and H₂ in the desired ratio (e.g. 1:3) can be provided to reactor 12 via inlet 16 the total flow maintained at a suitable rate.

In reactor 12, contact of the nitrogen and hydrogen with the catalyst of the present invention produces ammonia. Conditions sufficient to produce ammonia include temperature, time, and pressure. Specifically, the production of ammonia from nitrogen (N₂) and hydrogen (H₂) includes a temperature range from 15° C. to 260° C. or greater than, equal to, or between any two of 15° C., 20° C., 30° C., 40° C., 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., 250° C., and 260° C.). Preferably the reaction temperature is 100° C. to 200° C., preferably 150° C. The production of ammonia from N₂ and H₂ includes an average pressure from atmospheric, or 0.1 MPa to 2 MPa and all ranges and pressures there between (e.g., 0.2 MPa, 0.3 MPa, 0.4 MPA, 0.5 MPa, 0.6 MPa. 0.7 MPa, 0.8 MPa, 0.9 MPa, 1.0 MPa, 1.1 MPa, 1.2 MPa, 1.3 MPa, 1.4 MPa, 1.5 MPa, 1.6 MPa, 1.7 MPa, 1.8 MPa, or 1.9 MPa). Preferably the reaction pressure is 1 MPa to 2 MPa, preferably 1.5 MPa. The upper limit on temperature and/or pressure can be determined by the reactor used. The reaction conditions may be further varied based on the type of the reactor used. The reactants can be heated for a time sufficient to produce a desired amount of ammonia. The time of reaction can be controlled by reactant supply or catalyst activity (e.g., TON). By way of example, the reaction time range can be at least 1 hour, at least 6 hours, at least 200 hours, at least 500 hours or until the catalyst is considered deactivated (e.g., ammonia is not produced in sufficient amount or is not produced).

An ammonia containing stream can be removed from reactor 12 via outlet 18. The reaction can be monitored by removing a portion of the ammonia stream and providing the removed portion to an acid trap containing a solution of H₂SO₄. NH₃ formed from the reaction can be trapped in the acid and quantitative estimation of NH₃ being formed can be done by volumetric titration of the definite amount of acid withdrawn from the trap over a period of time. In other embodiments of the process, the metal hydride material of the present invention can have a turnover rate number (TON) of at least 1, at least 50, at least 100. In a non-limiting examples, the TON in the presence of a supported titanium hydride material (1.29 wt. % Ti) with a N₂:H₂=1:3 for a reaction time of 10 hours, the TON can be 7.2 at 50° C. with 1.9 mmols/g of NH₃ in the gas phase; 12.6 at 100° C. with 3.4 mmols/g of NH₃ in the gas phase; and 16.2 at 250° C. with 4.4 mmols/g of NH₃ in the gas phase.

The resulting ammonia produced from the processes of the current invention can be highly pure. However, if necessary, the resulting ammonia can be further purified and/or dried using common liquid or gas purification and/or drying techniques, such as fractional freezing (freezing distillation). The process can further include storing the directly produced or subsequently purified and/or dried ammonia.

A. D. Reactants and Products

Nitrogen (N₂) gas and hydrogen (H₂) gas can be obtained from various sources. In one non-limiting instance, the N₂ gas is an industrial gas produced by the fractional distillation of liquid air, or by mechanical means using gaseous air (i.e., pressurized reverse osmosis membrane or pressure swing adsorption). N₂ gas can also be obtained from a N₂ gas generator using membranes or PSA which are typically more cost and energy efficient than bulk delivered nitrogen. N₂ gas may also be obtained as a byproduct of air processing for industrial concentration of oxygen for steelmaking and other purposes. Without limitation N₂, gas for use in the current invention may be supplied in compressed cylinders as OFN (oxygen-free nitrogen). The hydrogen may be from various sources, including streams coming from other chemical processes, like water splitting (e.g., photocatalysis, electrolysis, or the like), syngas production, ethane cracking, methanol synthesis, or conversion of methane to aromatics. When a mixture of gas is used, such as a mixture of N₂ and H₂, the gas can be premixed or mixed when added separately to the reactor. When the reactor contains a mixture of N₂ and H₂, the volume ratio of N₂ to H₂ (N₂:H₂) can be 1:1 to 1:4 and all ranges in ratios there between (e.g., 1:1.1, 1:1.2, 1:1.3, 1:1.4, 1:1.5, 1:1.6, 1:1.7, 1:1.8, 1:1.9, 1:2, 1:2.1, 1:2.2, 1:2.3, 1:2.4, 1:2.5, 1:2.6, 1:2.7, 1:2.8, 1:2.9, 1:3, 1:3.1, 1:3.2, 1:3.3, 1:3.4, 1:3.5, 1:3.6, 1:3.7, 1:3.8, or 1:3.9), preferably 1:3. In some examples, the remainder of the reactant gas can include another gas or gases provided the gas or gases are inert, such as argon (Ar), further provided that they do not negatively affect the reaction. Preferably, the reactant mixture is highly pure (e.g., Grade 6 purity) and substantially devoid of water and oxygen. In some embodiments, the N₂ and/or H₂ can be dried prior to use (e.g., pass through a drying media) or contain a minimal amount of water or no water at all. Water can be removed from the reactant gases with any suitable method known in the art (e.g., condensation, liquid/gas separation, etc.). In some embodiments, the gases are passed through moisture and oxygen filters to remove moisture and oxygen to lower the water and oxygen content of the gases to a desired level, preferably, to level undetectable using known gas purity analysis methods.

The process of the present invention can produce a product stream of ammonia (NH₃) that can be suitable as an intermediate or as feed material in a subsequent synthesis reactions to form a chemical product or a plurality of chemical products. In some embodiment, a portion of the ammonia is adorbed on the metal hydride material. Without being limited by theory, the produced NH₃ can be collected and/or purified and stored or sold, and/or used in other processes (e.g., fertilizer manufacturing, nitric acid manufacture, metal treating operations, metal extraction, water and wastewater treament, stac emission control systems, photochemical processes, industrial refergeration systems, pulp and paper processes, rubber manufacture, chemical processes to produce leather and/or rubber, etc.).

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

### Example 1

### (Preparation of Neopentyl Lithium (LiCH₂CMe₃))

Neopentyl lithium was prepared by reacting neopentyl chloride (10 g) and finely chopped Li wire (3 g, 1% Na) in hexane according to Davidson et al., (Organomet. Chem. 1973, 57, 269) to afford 5-6 g of neopentyl lithium (70-80% yield).

### Example 2

### (Preparation of Tetraneopentyltitanium, TiNp₄ or [Ti(CH₂CMe₃)₄])

To a solution of neopentyllithium in pentane (50 mL of a 0.65 M solution, 32.5 mmol) was added Ti(OEt)₄ (1.5 mL, 7.3 mmol) in pentane (20 mL). The reaction mixture was stirred for 1.5 h at −78° C. and then for 6 h at room temperature. The solvent was then removed to obtain the brown solid which was purified by sublimation (55° C., 10⁻³ Torr) over 10 h to give the product according to Clark et al., J. Am. Chem. Soc., 1978, 100, 6774 and McCullough et al., J. Am. Chem. Soc., 1985, 107, 5987.

### Example 3

### (Preparation of Active Complex Hydride [(≡Si—O)ₓTiH_{y}])

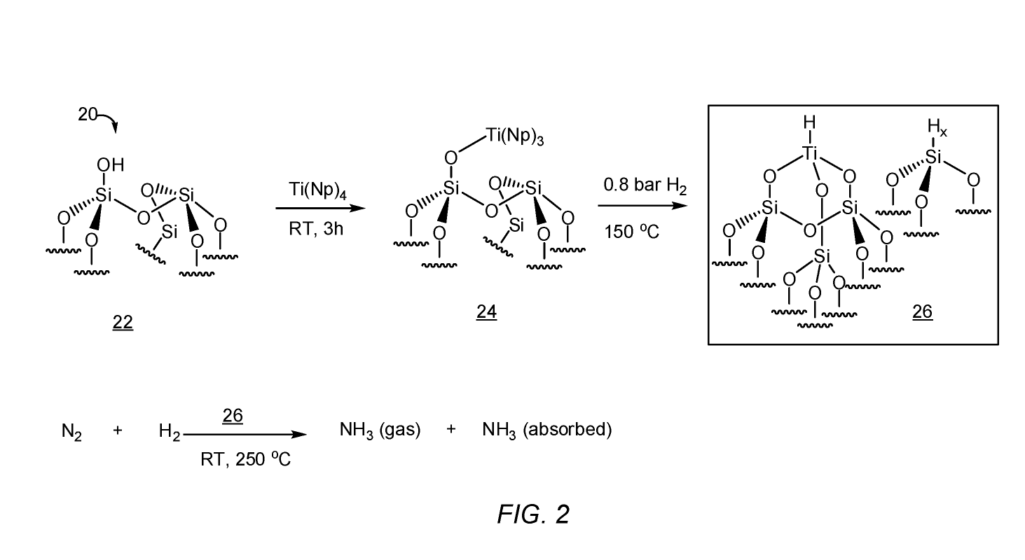

A mixture of Ti(Np)₄/[Ti(CH₂CMe₃)₄] (0.1 g, 0.3 mmol) in pentane (10 ml) and SiO₂-(700, ≡SiOH) (1 g, 0.3 mmol of SiOH) was stirred at 25° C. for 3 h in a double schlenk with a small pore silica frit. After filtration the solid was washed three times with pentane and dried for 15 min under vacuum at 25° C. to produce surface complex (≡SiO)Ti—Np₃. FIG. 2 is a reaction schematic showing the preparation of the surface complex and the catalysis of ammonia production from nitrogen and hydrogen gases. Referring to FIG. 2, ≡SiOH 22 is reacted with Ti(Np)₄ to form surface complex 24 ((≡SiO)Ti—Np₃). Surface complex 24 is treated with hydrogen gas to form supported metal hydride 26 of the present invention. Supported metal hydride 26 can be reacted with N₂ and H₂ under conditions suitable to produce ammonia gas and absorbed ammonia on the surface support

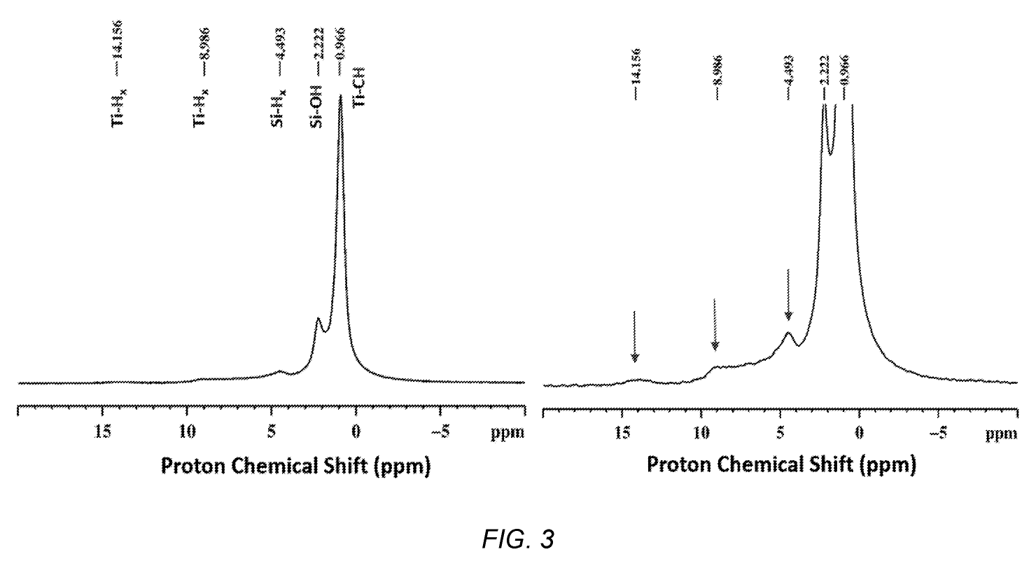

Anhydrous H₂ (1 bar) and the surface complex (≡SiO)Ti—Np₃ (0.3 g, 0.056 mmol of metal) were heated at 100-150° C. for 15 h in a glass reactor (480 ml) in the dark to give [(≡SiO)ₓTiH_{y}]. The active catalysts were characterized. FIG. 3 shows the NMR spectra of [(≡Si—O)TiH_{y}]. Weak signals around 14.1 and 8.9 ppm correspond to the different Ti—Hₓ species. Signals corresponding to Si-Hx and Si—OH could be seen around 4.5 ppm and 2.2 ppm respectively. An intense signal around 0.96 ppm corresponds to residual alkyls remaining on the surface after hydrogenation. Elemental analysis of [(≡Si—O)ₓTiH_{y}] showed around 0.54% C; 0.17% H and 1.29% Ti.

### Example 4

### (Preparation of Tetraneopentylzirconium: ZrNp₄ or [Zr(CH₂CMe₃)₄])

Molecular precursor ZrNp₄ was prepared according to Cheon et al., J. Am. Chem. Soc., 1997, 119, 6804-6813 with 4.35 g of ZrC1₄ (18.65 mmol) and 57 ml of NpMgCl at 1.46 M (84 mmol, 4.5 equiv.). The white solid was purified by sublimation to afford ZrNp₄ in 70% yield.

### Example 5

### (Preparation of Tetraneopentylhafnium: HfNp₄ or [Hf(CH₂CMe₃)₄])

Molecular precursor HfNp₄ was prepared according to Saint-Arroman et al., Applied Catalysis A: General, 290 (2005) 181-190; Davidson et al., J. Organomet. Chem. 1973, 57, 269 with 2.5 g of HfCl₄ (7.79 mmol) and 10.5 ml of NpLi at 3.12 M (32.72 mmol, 4.2 equiv.) at 0° C. in hexane. The white solid obtained was purified by sublimation in 60% yield.

### Example 6

### (Preparation of Mo(≡CCMe₃)(CH₂CMe₃)₃)

Molecular precursor Mo(≡CCMe₃)(CH₂CMe₃)₃ was prepared by the reaction of molybdenum oxo chloride with neopentyl magnesium chloride in the ratio 1:6 using hexane/ether as the solvent at temperatures starting from −70° C. to 25° C. for around 5 hours according to Davidson et al.

### Example 7

### (Preparation of Hexamethyltungsten W(CH₃)₆)

Molecular precursor W(CH₃)₆ was prepared from WC1₆ and (CH₃)₂Zn according to McCullough et al.; Samantaray et al., J. Am. Chem. Soc., 2013, 3, 136. To WCl₆ (1.80 g, 4.5 mmol) in dichloromethane (25 mL) was added (CH₃)₂Zn (13.6 mmol, 1.0 M in heptane) at 80° C. followed by warming the mixture to 35° C. and stirring at this temperature for another 30 min. After successive filtrations with pentane and removal of the solvent, W(CH₃)₆ as a red solid was obtained (0.16 g, 12%).

### Example 8

### (Preparation of [≡SiO—ZrNp₃] by grafting ZrNp₄ onto SiO₂-(700))

A mixture of ZrNp₄ (0.125 g, 0.33 mmol, 1.3 equiv.) in pentane (15 ml) and SiO₂-(700) (1.10 g, 0.26 mmol of ≡SiOH) was stirred at 25° C. for 2 h in a double schlenk with a small pore silica frit. After filtration the solid was washed three times with pentane and dried for 15 min under vacuum at 25° C.

### Example 9

### (Preparation of [≡SiO—HfNp₃] by Grafting HfNp₄ onto SiO₂-(700))

A mixture of HfNp₄ (0.30 g, 0.65 mmol, 1.4 equiv.) in pentane (15 ml) and SiO₂-(700) (2.0 g, 0.46 mmol of ≡SiOH) was stirred at 25° C. for 2 h in a double schlenk with a small pore silica frit. After filtration the solid was washed three times with pentane and dried for 15 min under vacuum at 25° C.

### Example 10

### (Preparation of [≡SiO—W(CH₃)₅] by grafting W(CH₃)₆ onto SiO₂-(700))

Grafting of W(CH₃)₆ was realized by stirring a mixture of an excess of [(≡Si—O)ₓTiH_{y}] and silica which had been partially dehydroxylated at 700° C. (i.e., SiO₂-700, which contains 0.3±0.1 mmol of silanol groups/g) at 50° C. under an inert atmosphere of argon. After several washing cycles with pentane and drying under high vacuum, yellowish white powder was formed.

### Example 11

### (Preparation of [≡SiO—W(CH₃)₅] by grafting W(CH₃)₆ onto SiO₂-(700))

Grafting of W(CH₃)₆ was realized by stirring a mixture of an excess of [(≡Si—O)ₓTiH_{y}] and silica which had been partially dehydroxylated at 700° C. (i.e., SiO₂-700, which contains 0.3±0.1 mmol of silanol groups/g) at 50° C. under an inert atmosphere of argon. After several washing cycles with pentane and drying under high vacuum, yellowish white powder was formed.

### Example 12

### (Preparation of [≡SiO—ZrNp₃] by Grafting ZrNp₄ onto SiO₂-(700))

A mixture of ZrNp₄ (0.125 g, 0.33 mmol, 1.3 equiv.) in pentane (15 ml) and SiO₂-(700) (1.10 g, 0.26 mmol of ≡SiOH) was stirred at 25° C. for 2 h in a double schlenk with a small pore silica frit. After filtration the solid was washed three times with pentane and dried for 15 min under vacuum at 25° C.

### Example 13

### (Preparation of [≡SiO≤HfNp₃] by grafting HfNp₄ onto SiO₂-(700))

A mixture of HfNp₄ (0.30 g, 0.65 mmol, 1.4 equiv.) in pentane (15 ml) and SiO₂-(700) (2.0 g, 0.46 mmol of ≡SiOH) was stirred at 25° C. for 2 h in a double schlenk with a small pore silica frit. After filtration the solid was washed three times with pentane and dried for 15 min under vacuum at 25° C.

### Example 14

### (Preparation of [≡SiO—W(CH₃)₅] by grafting W(CH₃)₆ onto SiO₂-(700))

Grafting of W(CH₃)₆ was realized by stirring a mixture of an excess of 1 and silica which had been partially dehydroxylated at 700° C. (i.e., SiO₂-700, which contains 0.3±0.1 mmol of silanol groups/g) at 50° C. under an inert atmosphere of argon. After several washing cycles with pentane and drying under high vacuum, yellowish white powder was formed.

### Example 15

### (Preparation of Active Complex Hydrides [(Si—O)ₓMH_{y}] where M=Ti, Zr, Hf, W and Mo)

Typically, anhydrous H₂ (1 bar) and the surface complex (≡SiO)M-Np₃ (0.3 g, 0.056 mmol of metal) were heated at 150° C. for 15 h in a glass reactor tube (480 ml) in the dark to give [(≡SiO)ₓMH_{y}] and the gas phase was quantified by GC. In order to make [(≡SiO)xW-H_{y}], [(≡SiO)W-Me_{y}] was treated with H₂ (0.8 bar) @ 70° C. for 6 hours.

### Example 16

### (Preparation of Active Bimetallic Complex Hydrides [(≡Si—O)ₓMH_{y}][≡Si—O)ₓM′H_{z}] where M=Ti, and M′=W)

After grafting W(CH₃)₆ onto SiO₂-700, the solvent was filtered and removed. The solid powder obtained was dried and [(≡SiO)Ti—Np₃] in pentane was added in 0.6:1 metal (W/Ti) ratio. The yellowish powder obtained was then hydrogenated with 0.8 bar of H₂ in 800 ml glass reactor @ 100° C. for 15 hours to afford the corresponding bimetallic hydride.

### Example 17

### Ammonia Production Using Catalysts of the Present Invention—General Methods

1. In-Situ IR Monitoring in an IR Cell

A MHₓ sample (˜30 mg) was made into a pellet and placed in an IR cell maintained under controlled atmosphere. The IR cell was evacuated and the IR spectrum was recorded. A side chamber with an adaptor containing 0.6 bar of dry H₂ was fitted to the IR cell. The IR cell was first filled with 0.2 bar of N₂ followed by 0.6 bar of dry H₂. Reaction progress was monitored by recording the IR spectra at different temperatures at definite intervals of time. Heat treatments in N₂ and H₂ at different temperatures such as 25° C., 50° C., 100° C. and 250° C. each for 10 hours were tested and the surface reactions were monitored.

2. Reaction with N₂ and H₂ in a PID Dynamic Reactor

An active hydride complex (˜200 mg) was loaded into a stainless steel reactor of half inch diameter, which can be separated from ambient atmosphere. The reactor was then connected to a PID reaction chamber. Gas lines were first purged using dry N₂ to remove any traces of air and moisture. Reactant gases, N₂ and H₂ in the ratio 1:3 were then flowed to the catalyst chamber and the total flow maintained was 4.2 ml/min. The outlet was connected to an acid trap maintained at 0° C. containing 10⁻⁴ M solution of H₂SO₄. NH₃ formed was trapped in the acid. Quantitative estimation of NH₃ being formed was done by volumetric titration of the definite amount of acid withdrawn from the trap over a period of time. Dynamic reactions were done at different temperatures by a temperature ramp while allowing the reaction to proceed for 10 hours at specific temperatures such as 25° C., 50° C., 100° C. and 250° C.

### Example 18

### (Production of Ammonia Using [(Si—O)ₓTiH_{y}] of the Present Invention)

Using [(≡Si—O)ₓTiH_{y}] on silica (Aerosil) dehydroxylated at 700° C. (e.g., a sample prepared as described in Example 3), it was demonstrated that a catalytic process could be accomplished forming ammonia from N₂ and H₂ under ambient conditions and the TON observed varied from 6 at 50° C. to 16 at 250° C. with the temperature ramp at periodic intervals of 10 hours. Dynamic reaction activities of complex [(≡Si—O)ₓTiH_{y}] are shown in Table 1. The amount of complex (200 mg) corresponded to 0.0539 mmols of Ti and mononuclear SiO₂-700 was used as the support. From the TON, it was determined that catalytic conversion of N₂ to NH₃ occurred. Notably, the TON was almost 100 times the TON of active TaH_{y} on SiO₂-700 (TON=0.071). Without wishing to be bound by theory, it is believed that a tris hydride of Ti forms by hydrogenation of [≡Si—O—TiNp₃, where ≡ represents the support] (See, FIG. 2) but, a more stable monohydride of Ti can predominant by hydride transfer resulting in the simultaneous generation of ≡Si—H/═SiH₂ which might also play a role in the process of N₂ reduction.

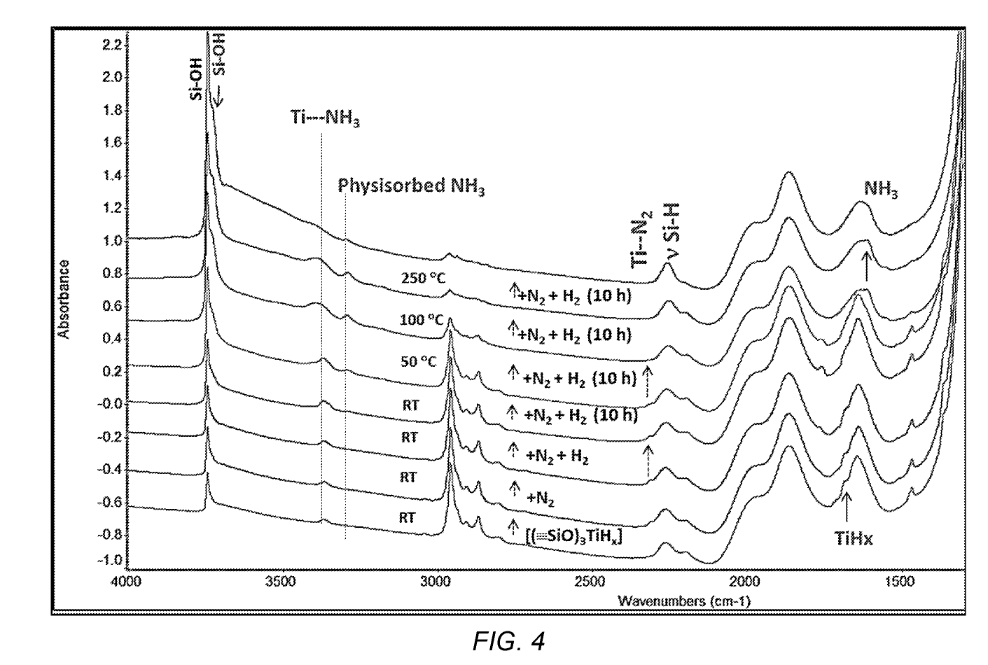

FIG. 4 shows the IR features of [(≡Si—O)ₓTiH_{y}] before, during and after reaction with N₂ and H₂ under the specific reaction conditions used. FIG. 4 shows the in-situ IR spectrums of the [(≡Si—O)ₓTiH_{y}] before and after reaction with N₂ and H₂ at various temperatures. Starting hydride showed the Ti—Hₓ stretching frequencies around 1715, 1686, 1659, 1642 & 1618 cm⁻¹ and Si—H and Si—H₂ stretching frequencies are around 2262 cm⁻¹ and 2195 cm⁻¹. Among the many types (mono, bis and tris) of Ti—Hₓ formed, some specific type of hydrides are highly active and it even reacts with the 5 ppm of N₂ available inside the argon atmosphere of the glovebox at room temperature. Hence, the starting spectrum contained the chemisorbed NH₃ peak around 3369 cm⁻¹. The IR cell was further filled with 0.2 bar of N₂ at room temperature. Immediate coordination of N₂ was observed and the corresponding new bands appeared around 2342, 2312 and 2280 cm⁻¹. After adding H₂ and heating at 50° C., new bands corresponding to physisorbed NH₃ appeared. The bands corresponding to chemisorbed and physisorbed ammonia include 3369, 3290 and 3179 cm⁻¹. Upon further heating in N₂ and H₂ at 100° C. and 250° C., Ti—Hₓ bands diminished and the formation of more ammonia was observed.

Trace amounts of Si—NH₂ were detected around 1550 cm⁻¹ which might be formed because of the gas phase NH₃ interaction with siloxane bridges as the reaction was under static conditions at higher temperatures. The release of the adsorbed NH₃ above 150-250° C. suggests that the regeneration of Ti—Hₓ sites could be possible. Ti—Hₓ complex was much more active than the TaHₓ complex. NH₃ formed at room temperature was strongly bound to Ti and the release of NH₃ happens upon heating to 50° C. or above. Unlike Ta—Hₓ (See, Example 19) no splitting of NH₃ into Ti(NH₂)(═NH) was observed in the case of Ti—Hₓ even after heating up to 250° C.

TABLE 1

| Ti | Reaction conditions | | Time of the | NH₃ in the gas | |
|---|---|---|---|---|---|
| (wt. %) | N₂:H₂ | Temp. (° C.) | reaction (h) | Phase (mmols/g) | TON |
| 1.29 | 1:3 | 25 | 0 | 0 | 0 |
| 1.29 | 1:3 | 25 | 10 | 0 | 0 |
| 1.29 | 1:3 | 50 | 10 | 1.9 | 7.2 |
| 1.29 | 1:3 | 100 | 10 | 3.4 | 12.6 |
| 1.29 | 1:3 | 250 | 10 | 4.4 | 16.2 |

### Example 19

### (Production of Ammonia Using [(Si—O)ₓTaH_{y}] of the Present Invention)

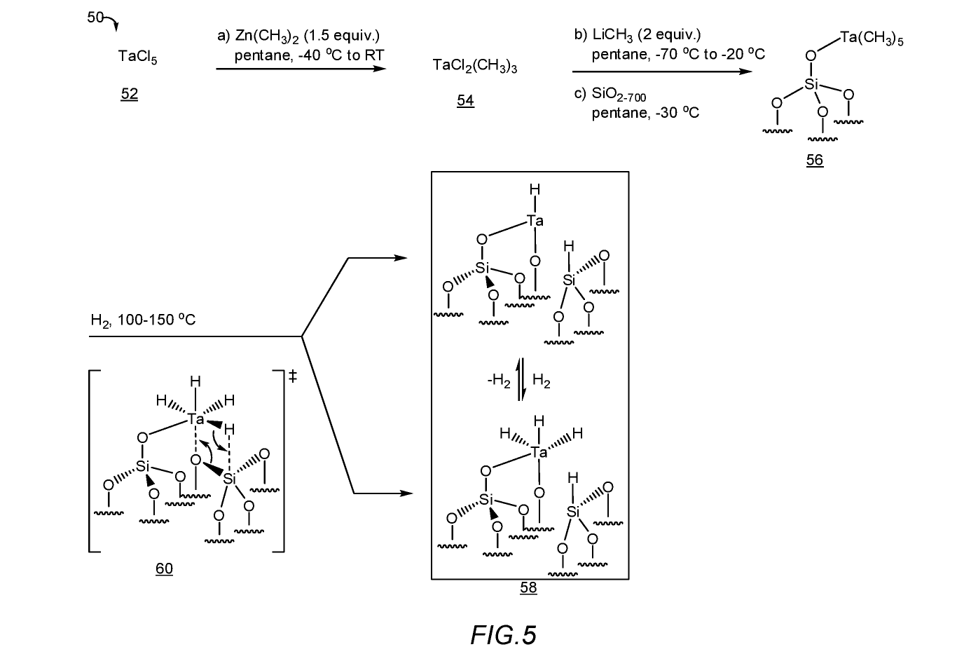

Active TaHy complex on SiO₂-700 was prepared from corresponding methyl precursors following the literature procedures (Chen et al., Organometallics 2014, 33, 1205-1211; Chen et al., J Am Chem Soc. 2015, 137(2), 588-591; and Schrock et al., J Am Chem Soc, 1974, 96, 5288-5290). FIG. 5 shows the reaction schematic 50 for the formation of [(≡Si—O)ₓTaH_{y}]. TaCl₅ 52 is reacted with Zn(CH₃)₂ to form TaCl₂(CH₃)₃ 54 that is further reacted with LiCH₃ and SiO₂ to form [(≡Si—O—Ta(CH₃)₄] 56 that can be hydrogenated to form supported metal hydride of the present invention (e.g., [(≡Si—O)ₓTaH_{y}]) 58. Without wishing to be bound by theory, it is believed that transition structure 60 may be formed during the hydrogenation reaction.

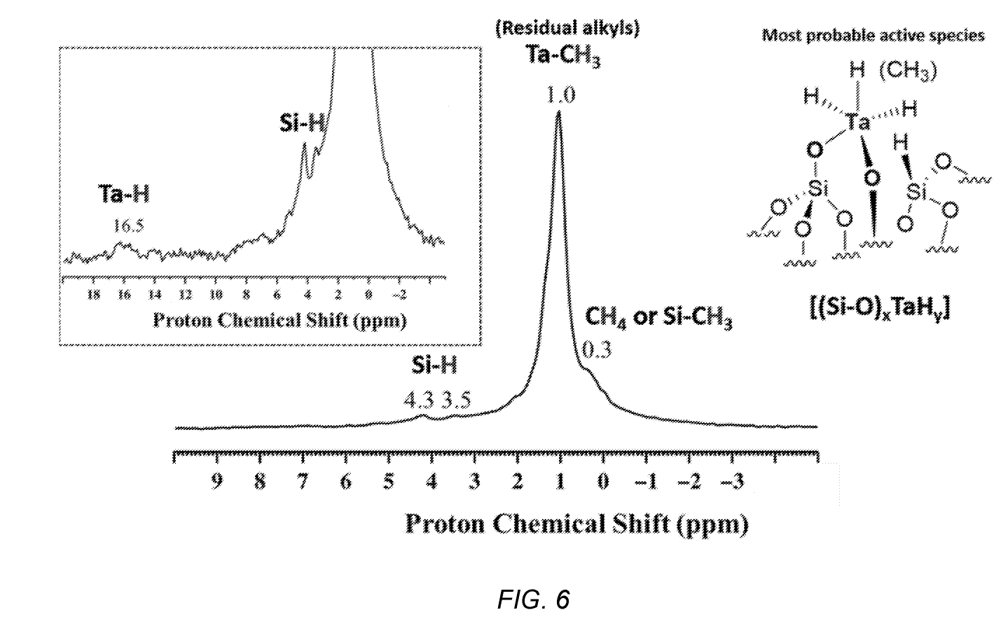

Tantalum hydride complexes on SiO₂-700 showed the formation of ammonia at room temperature and atmospheric pressure. However, heating at temperatures above 100° C. resulted in the splitting of ammonia on this surface resulting in the formation of surface amido imido complex. FIG. 6 shows the ¹H NMR spectrum of [(≡Si—O)ₓTaH_{y}]. The ¹H-MAS NMR spectrum of the corresponding sample displays a main signal at 1 ppm corresponding to residual Ta—CH₃, as well as several peaks of weak intensity at 3.5 & 4.3 ppm corresponding to SiHx and 0.0 ppm corresponding to evolved gas phase CH₄ or Si—CH₃. Signal corresponding to SiNH₂/NH₃ protons should be around 1.1 ppm and 2.3 ppm respectively which cannot be distinguished in the current spectrum because of the broad signal at 1.0 ppm.

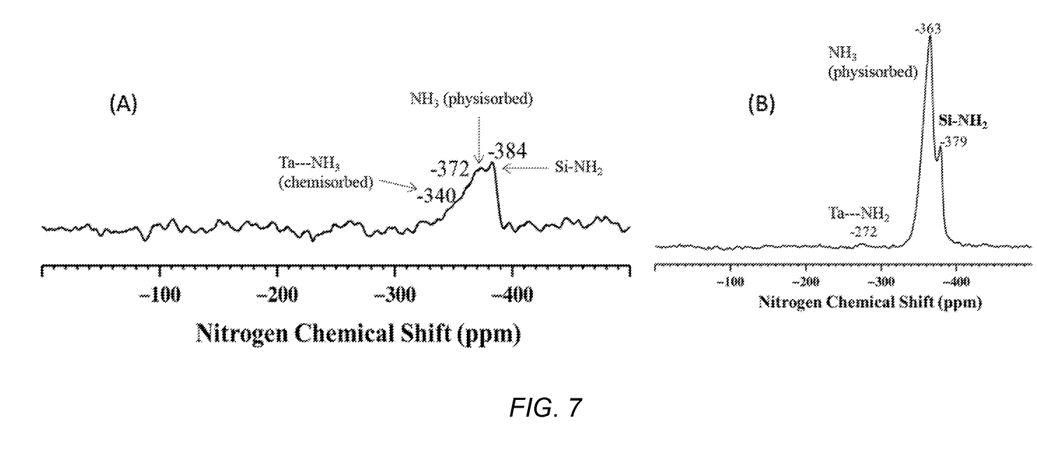

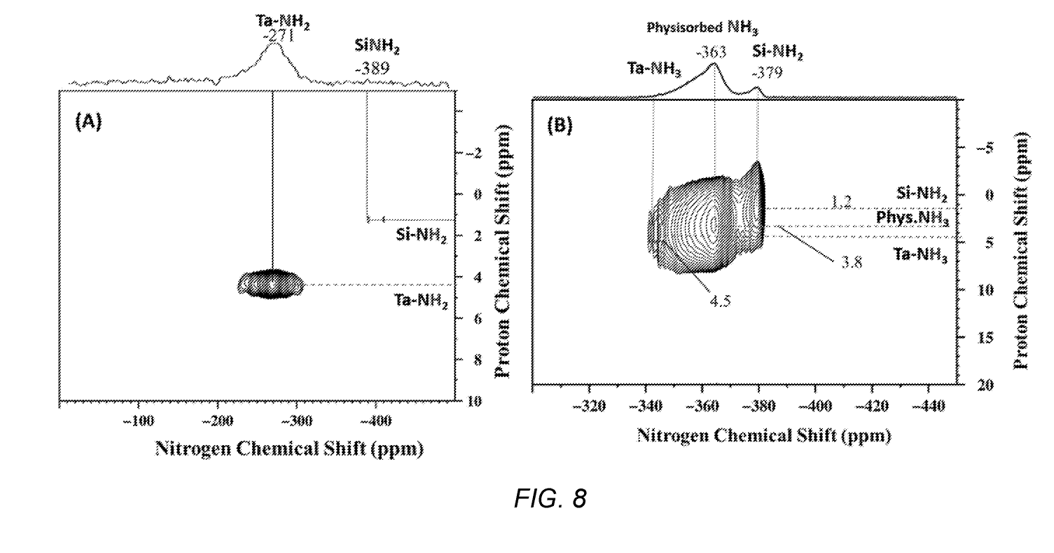

FIG. 7 shows the ¹⁵N-MAS NMR spectrum of [(≡Si—O)ₓTaH_{y}] after treatment with ¹⁵N₂ and H₂ at room temperature displays a broad signal ranging from −320 ppm to −400 ppm corresponding to chemisorbed and physisorbed ammonia and Si—NH₂. Among the two main signal around −372 ppm is assigned to physisorbed ¹⁵NH₃ and −384 ppm is assigned to Si—NH₂. FIG. 8 shows heteronuclear correlation (HETCOR) experiments of [(≡Si—O)ₓTaH₃]. 2D spectrum (A) shows the ¹⁵N₂-1H HETCOR spectrum that heat treatment for 10 hours at temperatures above 100° C. resulted in the formation of Ta—NH₂. 2D spectrum (B) shows the ¹⁵N₂-1H HETCOR spectrum of [(≡Si—O)ₓTaH_{y}] after reaction with ¹⁵NH₃ at room temperature. Spectrum (B) also shows some amounts of Ta—NH₂ in accordance with the literature reports that [(≡Si—O)ₓTaH_{y}] can split NH₃ at high concentrations, however this region was not shown in the HETCOR spectrum.

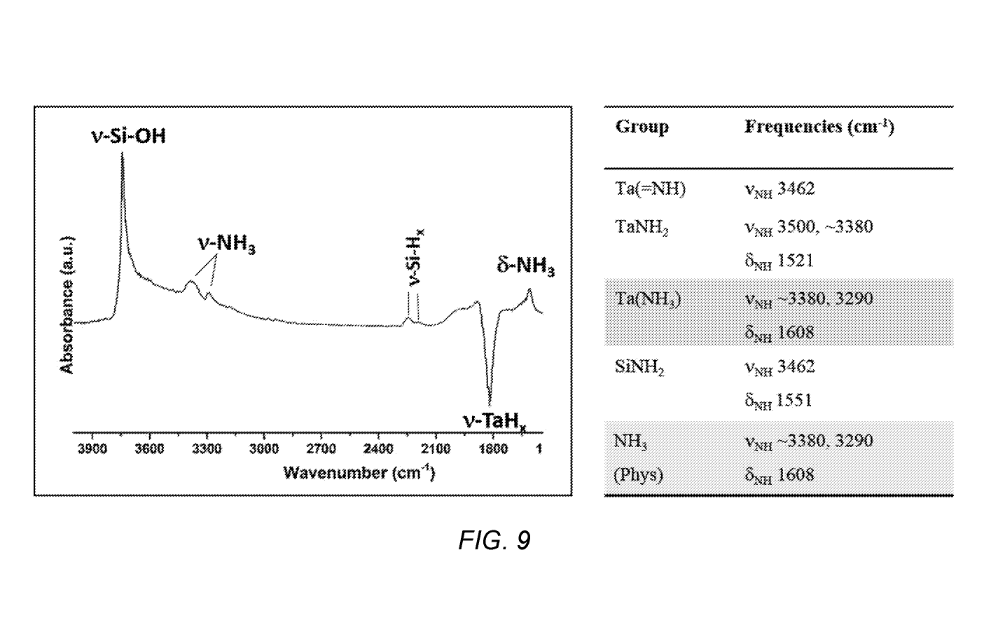

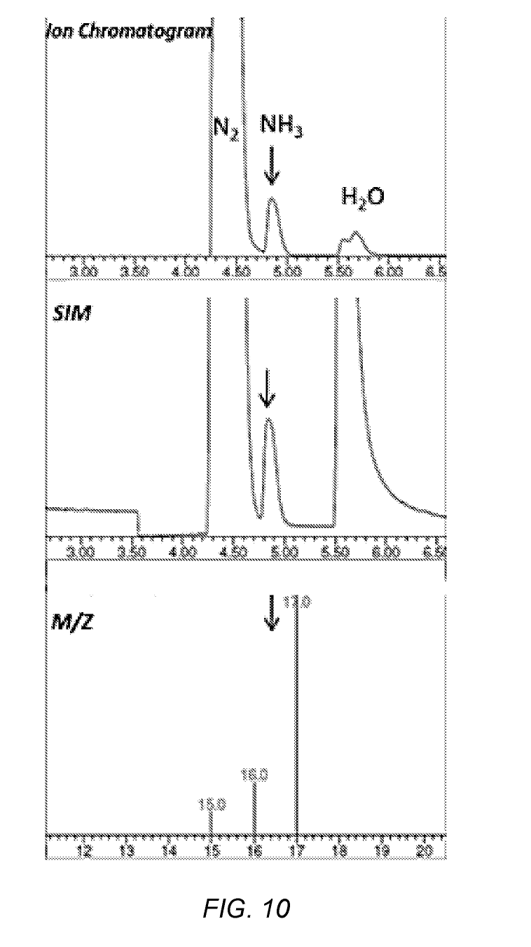

FIG. 9 shows the IR difference spectra corresponding to the [(≡Si—O)ₓTaH_{y}] before and after reaction with N₂ and H₂. Chemisorbed and physisorbed ammonia was observed after reaction with N₂ and H₂ at room temperature. Some positive changes in the SiHx and SiOH signals were observed along with the disappearance of the TaHx signals. The table shown in FIG. 9 corresponds to the frequencies expected for chemisorbed and physisorbed ammonia. FIG. 10 depicts the GC-MS chromatogram showing the detected NH₃ in the gas phase for the static reaction [(≡Si—O)ₓTaH_{y}] with N₂ and H₂ is provided as an additional proof for the formation of NH₃.

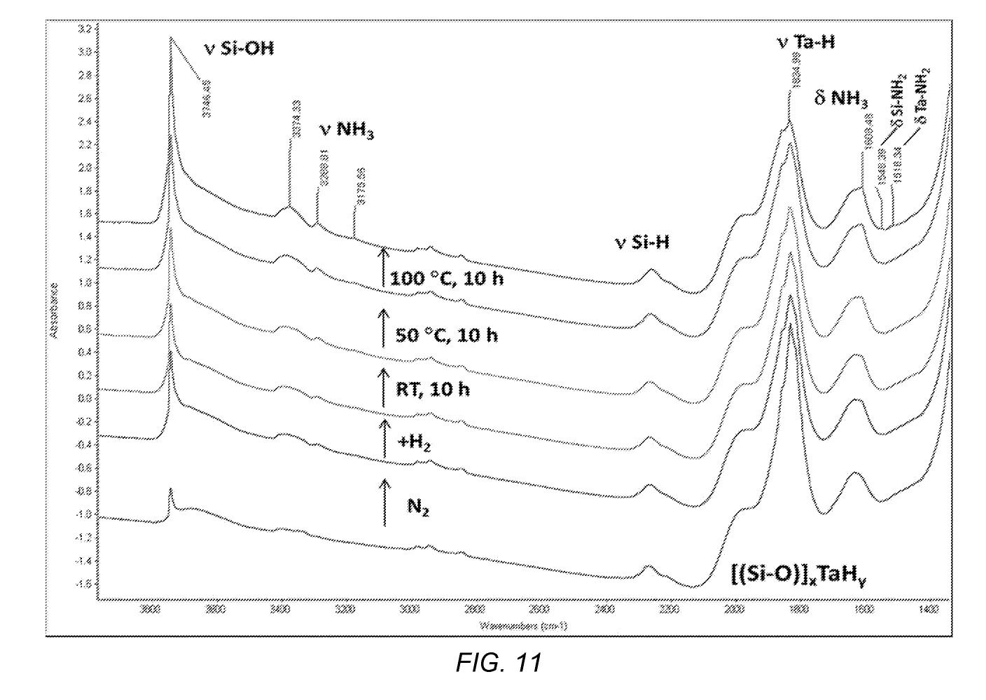

Hydrogenolysis of [(≡SiO)ₓTaMe_{y}] was carried out by the reaction with H₂ (0.8 bar) at 150° C. for 15 hours to generate [(≡SiO)xTaHy]. FIG. 11 shows the reaction of [(≡SiO)ₓTaH_{y}] with N₂ and H₂ at room temperature up to 100° C. was monitored stepwise by IR spectroscopy. Starting (≡SiO)ₓTaH_{y} shows the bands corresponding to Ta—H stretching around 1830 cm⁻¹ and Si—H stretching around 2270 and 2220 cm⁻¹. Some residual alkyl species still remained on the surface as shown by the CH stretching bands observed in the region around 3000 cm⁻¹. After reaction with N₂ and H₂ at room temperature, IR spectrum of [(≡SiO)ₓTaH_{y}] showed the appearance of the bands corresponding to ammonia at 3374, 3288 and 3175 cm⁻¹. Another band appeared around 1608 cm⁻¹ corresponds to the characteristic bending vibration of the gas phase ammonia. Bands corresponding to Ta—Hₓ diminished upon the addition of nitrogen. A considerable increase in the bands corresponding to silanols and Si—H also is visible. It could be due to the reaction of H₂ generated in-situ with strained Si—O—Si bridges upon coordination of N₂ to [(≡SiO)ₓTaH_{y}]. After heat treatment at 100° C. for 10 hours, splitting of ammonia was observed, which is indicated by the bands corresponding to Ta—NH₂ and Si—NH₂.

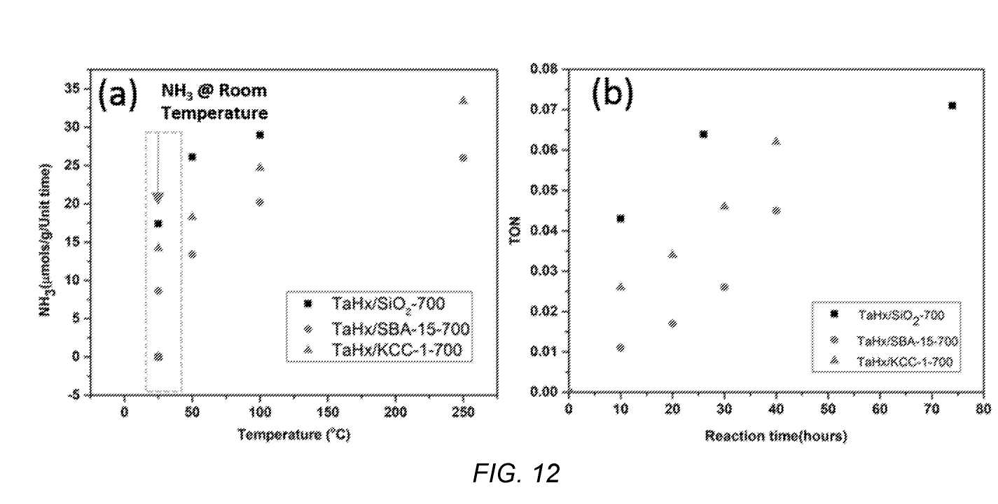

FIG. 12 shows dynamic reaction activities of [(≡SiO)ₓTaH_{y}] obtained on various silica supports for (a) NH3 formed vs. temperature and (b) TON vs. time. The supports selected were either amorphous/crystalline/porous or nonporous. The supports used were Aerosil SiO₂, SBA-15 and KCC-1. Three supports were dehydroxylated at 700° C. and then used for grafting. Among the three samples [(≡SiO)ₓTaH_{y}] on Aerosil SiO₂-700 showed the highest activity, though over all activities were not as high compared to [(≡SiO)ₓTiH_{y}]. By varying the dehydroxylation temperature, loading and strain on the surface also varied. By using aerosil SiO₂-1000 the activity improved four fold than that of SiO₂-700, however a faster deactivation was dominant on this sample.

A dissociative mechanism was anticipated for the activation of nitrogen, initiated by the insertion of N₂ to the M-H bond and subsequent hydrogenations of this diazenido species to hydrazido species. Involvement of SiHx in the mechanism was anticipated during this step will eventually help to release one molecule of NH₃. Further H₂ additions successively result in an imido or amido surface moiety that helps to release the second molecule of ammonia thus regenerating the hydride active species.

### Example 20

### (Production of Ammonia from Bimetallic Hydride Complex [(≡Si—O)ₓWH_{y}][(≡Si—O)ₓTiH_{y}] of the Present Invention)

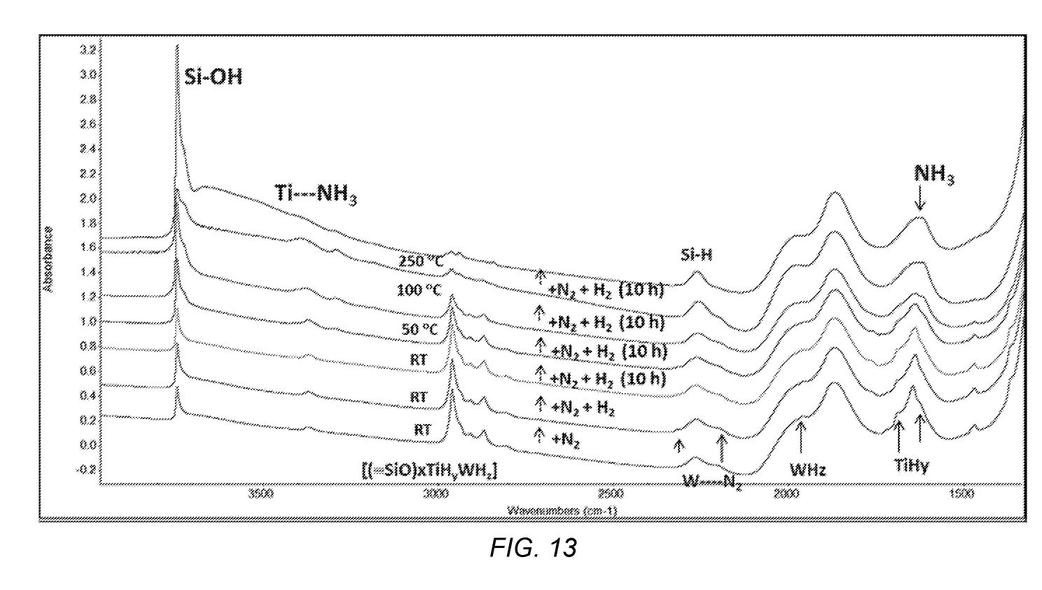

FIG. 13 shows the in-situ IR analyses of the reaction of [(≡Si—O)ₓWH_{y}][(≡Si—O)ₓTiH_{y}] with N₂ and H₂ at various temperatures. Bimetallic complex had a Ti:W ratio around 1:0.6. Starting hydride spectrum shows the weak bands of W—H_{y} around 1978, 1955, 1929 cm⁻¹ and strong bands of TiH_{y′} at 1715, 1686, 1659, 1642 & 1618 cm⁻¹. This complex showed better activities starting from the room temperature reactions. Upon exposure to N₂, band corresponding to the N₂ coordinated to W could be seen at 2317, 2276 and 2237 cm⁻¹ and that of N₂ coordinated to Ti at 2342, 2312 and 2280 cm⁻¹.Further heat treatments in presence of N₂ and H₂ resulted in enhanced activities resulting in more amount of adsorbed NH₃. This bimetallic complex had similar/better activities than that of TiH_{y} or WH_{y}. There was no splitting of NH₃ observed on this complex similar to that of TiH_{y}. Presence of some adsorbed NH₃ was observed even at 250° C. as WH_{y} favors the formation of ammonia at high temperatures.

### Example 21

### Production of Ammonia from of Other Transition Metal Hydrides of the Present Invention

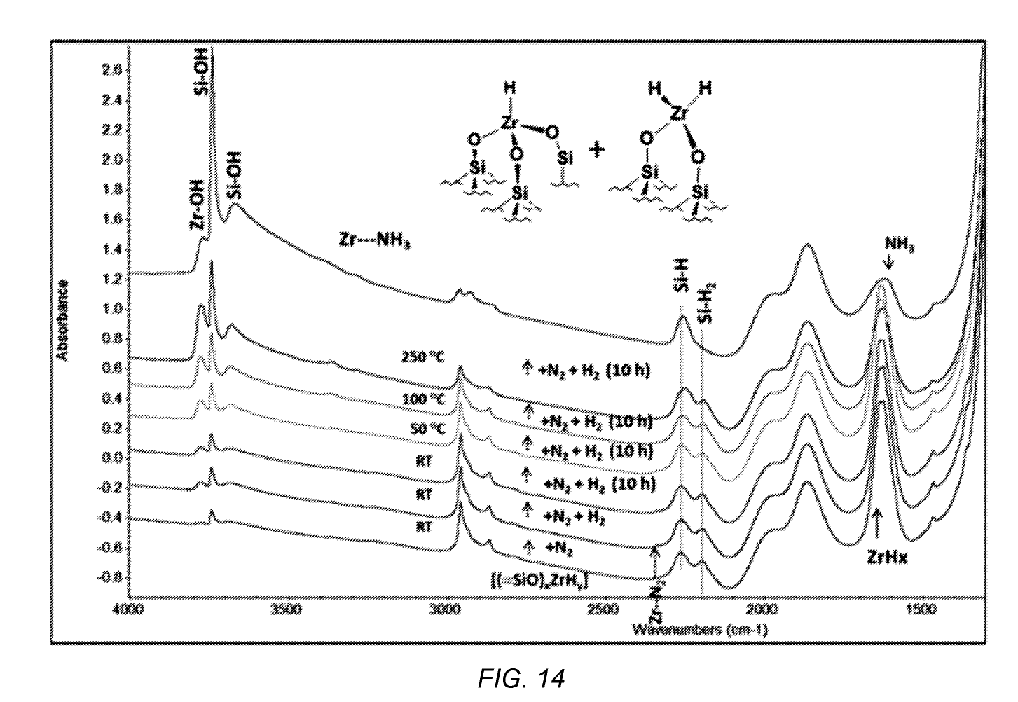

FIG. 14 shows the in-situ IR spectrums of the reaction of [(≡Si—O)ₓZrH_{y}] with N₂ and H₂ at various temperatures. Elemental analysis of [(≡Si—O)ₓZrH_{y}] showed 0.47% C and 0.12% H and 2.47% Zr. The starting hydride spectrum shows the intense bands of Zr—H_{y} around 1621 cm⁻¹. This complex did not show any bands corresponding to NH₃ at room temperature. After reaction with N₂ and H₂ for 10 h at room temperature, chemisorbed NH₃ was observed and further heating improved the activity. NH₃ splitting was not observed in the case of Zr—H_{y} also. When N₂ is introduced to the Zr—H_{y} pellet, coordination of N₂ was observed at room temperature around 2338 cm¹. Formation of Zr—OH and Si—OH was also observed when N₂ was introduced to the IR cell. This could be due to the reaction of Si—O—Zr bond with H₂/H⁻ forming Zr—OH. Si—OH formation was also observed as in the case of Ta. Further heating to high temperature showed the simultaneous increase in the formation of Zr—OH and Si—OH. Preliminary analysis indicates the probable leaching/de-grafting of the surface complex. It is also to be noted that after 250° C. heat treatment in presence of N₂ and H₂, bands corresponding to Si—H₂ vanished completely whereas Si—H concentration increased/remained same on the surface.

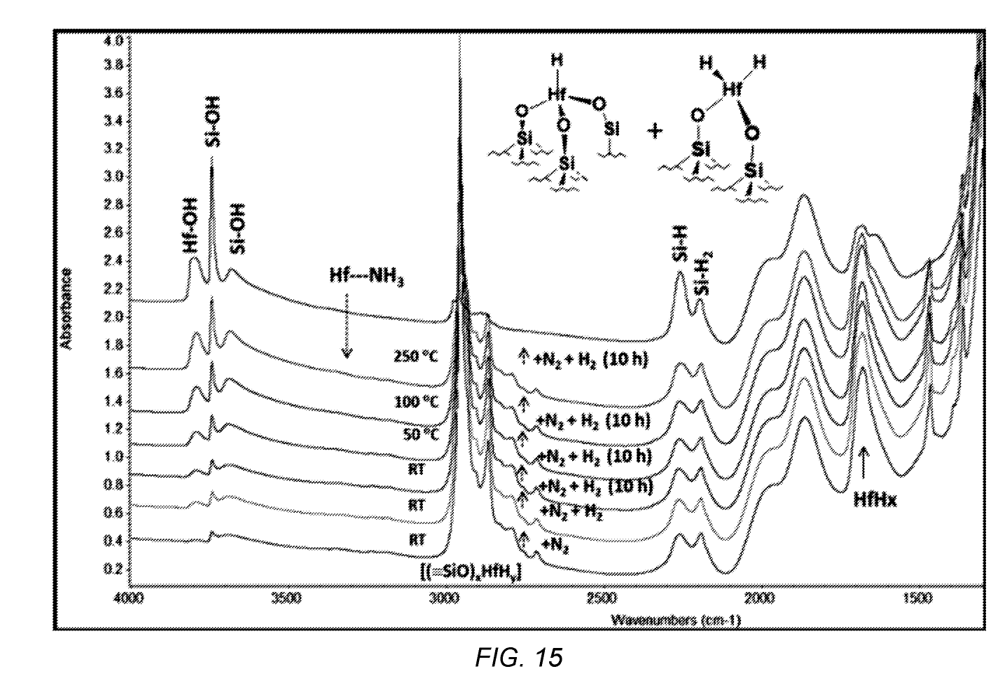

FIG. 15 shows the in-situ IR spectrums of the reaction of [(≡Si—O)ₓHfH_{y}] with N₂ and H₂ at various temperatures. Elemental analysis of [(≡Si—O)ₓHfH_{y}] showed 1.64% C and 0.36% H and 5.24% Hf. Starting hydride spectrum shows the bands of Hf—Hₓ around 1690 cm¹. This complex did not show any bands corresponding to NH₃ at room temperature. After reaction with N₂ and H₂ for 10 h at room temperature, negligible amount of chemisorbed NH₃ was observed and further heating did not improve the activity. NH₃ splitting was not observed in the case of Hf—Hₓ similar to the Zr—Hₓ. Weak bands of physisorbed and chemisorbed N₂ could be seen around 2336 cm¹ and 2167 cm¹ upon exposure to nitrogen. Upon increasing the heat treatment temperatures leaching/de-grafting induces the formation of Hf—OH and Si—OH similar to Zr—Hₓ.

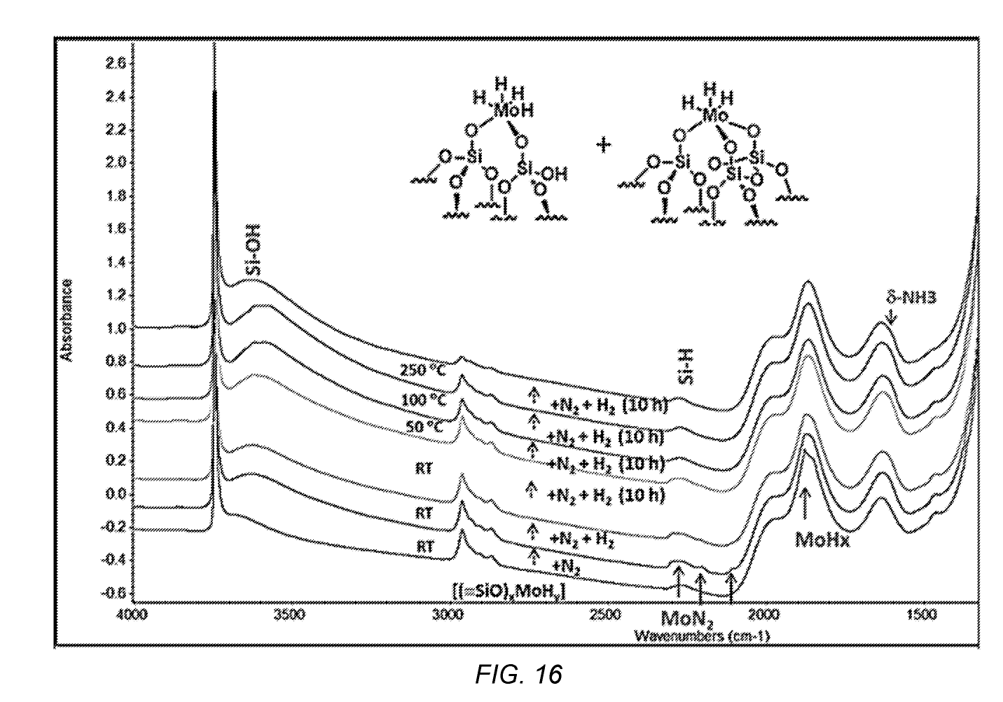

FIG. 16 shows the in-situ IR spectrums of the reaction of [(≡Si—O)ₓMoH_{y}] with N₂ and H₂ at various temperatures. Elemental analysis showed 2.45% of Mo. Starting hydride spectrum shows the bands of Mo—H_{y} around 1882, 1869, 1848 cm⁻¹. [(≡Si—O)ₓMoH_{y}] did not show any bands corresponding to NH₃ at room temperature. Upon exposure to N₂, band corresponding to the N₂ coordinated to Mo could be seen at 2304, 2295 and 2198 cm⁻¹. Further heat treatments in presence of N₂ and H₂ did not result in the formation of appreciable amount of NH₃, even at 250° C. However, very weak bands of physisorbed NH₃ were observed at 250° C.

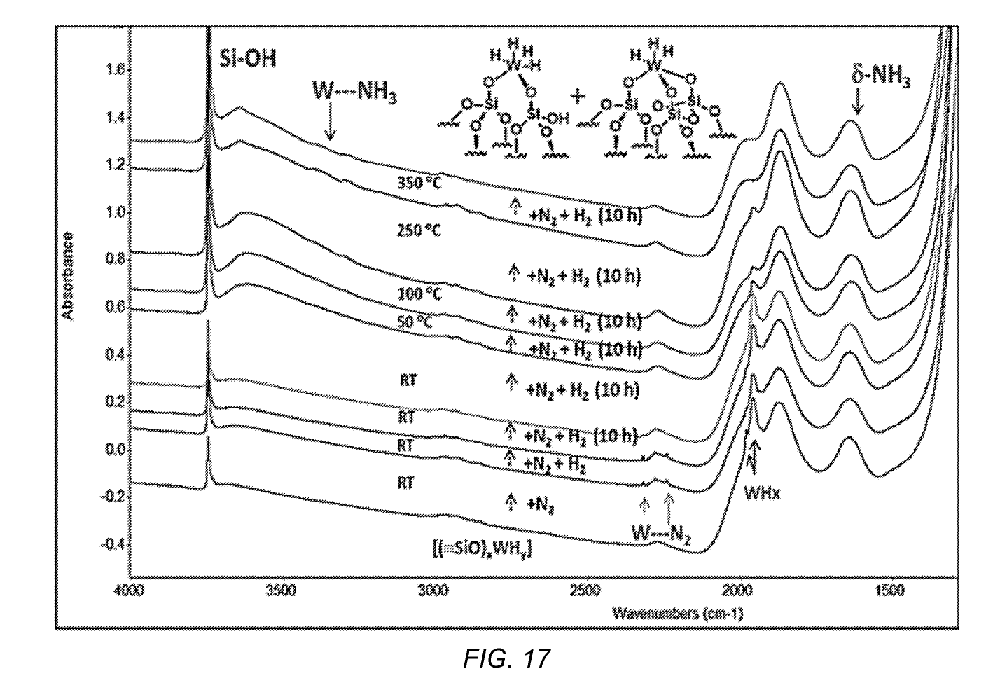

FIG. 17 shows the in-situ IR spectrums of the reaction of [(≡Si—O)ₓWH_{y}] with N₂ and H₂ at various temperatures. Elemental analysis showed 4.39% of W in the hydride. Starting hydride spectrum shows the bands of W—Hₓ around 1978, 1955, 1929 cm⁻¹. This complex did not show any bands corresponding to NH₃ at room temperature. Upon exposure to N₂, band corresponding to the N₂ coordinated to W could be seen at 2317, 2276 and 2237 cm⁻¹. Further heat treatments in presence of N₂ and H₂ resulted in the formation of comparatively negligible amount of NH₃. However, the observed activities were better than that of MoH_{y}. Table 2. Results for the ammonia formation activity on various transition metal complex hydride on different supports.

TABLE 2

| | Method of | | |
|---|---|---|---|
| | screening | | |
| | Dynamic | In-Situ | |
| Complex | reaction | IR | Observations |
| TaHₓ/SiO₂-700 | yes | yes | Appreciable activity |
| (Binuclear) | | | |
| TaHₓ/SiO₂-700 | yes | yes | Negligible activity |
| (Mononuclear) | | | |
| TaHₓ/SiO₂-1000 | yes | yes | Good activity, fast deactivation |
| TaHₓ/SBA | yes | yes | Less active, adsorbed NH₃ |
| 15-700 | | | stablized on SBA |
| TaHₓ/KCC-1-700 | yes | yes | Moderately active |
| TaHₓ/MgO-200 | no | no | Hydride species were not |
| | | | present/detected |
| TiHₓ/SiO₂-700 | yes | yes | Good activity, scope for |
| | | | regeneration |
| ZrHₓ/SiO₂-700 | no | yes | Less active, active species |
| | | | leaching suspected |
| HfHₓ/SiO₂-700 | no | yes | Less active, active species |
| | | | leaching suspected |
| MoHₓ/SiO₂-700 | no | yes | Less active, active only at high |
| | | | temperature, N₂ coordinates at RT |
| WHₓ/SiO₂-700 | no | yes | Less active, active only at high |
| | | | temperature, N₂ coordinates at RT |
| Ti—W(Hₓ)/ | no | yes | Similar activity to TiHₓ/SiO₂-700 |
| SiO₂-700 | | | |

1. A process for producing ammonia (NH₃) comprising contacting a gaseous feed mixture comprising nitrogen (N₂) and hydrogen (H₂) with a supported metal hydride material under reaction conditions sufficient to produce a product stream comprising NH₃, the metal hydride material has the formula:
[(R)ₓMH_{y}]
where:
M is a transition metal;
R is a hydrocarbon, a substituted hydrocarbon, or any combination thereof, preferably, an alkyl group, a substituted alkyl group, or any combination thereof;
0≤x;
1≤y; and
x+y is equal to the valence of M,
and the support is dehydroxylated silica (SiO₂).

2. The process of claim 1, wherein the reaction conditions comprise a temperature from 15° C. to 260° C., 100° C. to 200° C., preferably 150° C., a pressure of atmospheric pressure or 0.1 MPa to 2 MPa, 1 MPa to 2 MPa, preferably 1.5 MPa or both.

3. The process of claim 1, wherein a volume ratio of N₂ to H₂ (N₂:H₂) is 1:1 to 1:4, preferably 1:3.

4-5. (canceled)

6. The process of claim 1, wherein R comprises 1 to 7 carbon atoms, preferably 1 to 5.

7. The process of claim 6, wherein R is a methyl group, ethyl group, propyl group, isopropyl group, n-butyl group, sec-butyl group, tert-butyl group, pentyl group, neopentyl, hexyl group, or combinations thereof.

8. The process of claim 1, wherein the transition metal is scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), Lanthanide series, lanthanum (La), cerium (Ce), Actinide series, rutherfordium (Rf), dubnium (Db), seaborgium (Sg), bohrium (Bh), hassium (Hs), meitnerium (Mt), darmstadtium (Ds), roentgenium (Rg), or copernicum (Cn) or any alloy thereof.

9. The process of claim 1, wherein the transition metal is Ta, Ti, Zr, Hf, Mo, or W, preferably Ta or Ti.

10. The process of claim 9, wherein the transition metal is Ta, and metal hydride material has a general structure of: 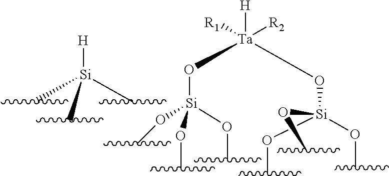
where R₁ and R₂ are each individually a hydrogen, a hydrocarbon, a substituted hydrocarbon group, or any combination thereof, preferably, an alkyl group, a substituted alkyl group, or any combination thereof.

11. The process of claim 10, wherein R₁ and R₂ are each hydrogen.

12. The process of claim 1, where the transition metal is Ti, and the metal hydride material has the general structure:

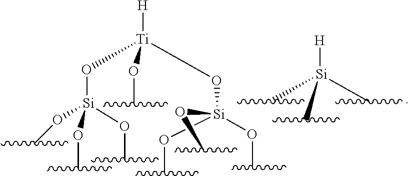

13. The process of claim 1, wherein the metal hydride material further comprises a second metal hydride material having the general formula:
[(R₂)ₜM²Hᵤ]
where:
M² is a transition metal with the proviso that M and M² are different;
R₂ is a hydrocarbon, a substituted hydrocarbon, or any combination thereof, preferably, an alkyl group, a substituted alkyl group, or any combination thereof;
0≤t;
1≤u; and
t+u is equal to the valence of M².

14. The process of claim 1, wherein the metal hydride material is in the form of a molecular complex, a molecular cluster, or a nanoparticle.

15. The process of claim 1, wherein a portion of the ammonia is adsorbed on the metal hydride material.

16. A supported metal hydride material capable of catalyzing the production of ammonia from nitrogen (N₂) and hydrogen (H₂), the metal hydride material having the formula of:
[(R)ₓMH_{y}]
where:
M is a transition metal;
R is a hydrocarbon, a substituted hydrocarbon, or any combination thereof, preferably, an alkyl group, a substituted alkyl group, or any combination thereof; and
0≤x, 1≤y, and x+y is equal to the valence of M,
and the support is double dehydroxylated SiO₂
wherein the metal hydride material is capable of catalyzing the production of ammonia from a mixture of nitrogen and hydrogen.

17. (canceled)

18. A method for preparing any one of the metal hydride materials of claim 16, the method comprising:
(a) obtaining a solution comprising an hydrocarbon anion (R⁻);
(b) reacting R⁻ with a transition metal (M) precursor to form a hydrocarbon metal (RₓM) material, where x is equal to the valence of M
(c) contacting the RAM with a double dehydroxylated silica support material to form a supported RₓM material; and
(d) treating the RₓM material with hydrogen (H₂) under conditions sufficient to form the catalyst having the general formula of:
[(R)ₓMH_{y}]
where:
M is a transition metal;
R is a hydrocarbon, a substituted hydrocarbon, or any combination thereof, preferably, an alkyl group, a substituted alkyl group, or any combination thereof; and
0≤x, 1≤y, and x+y is equal to the valence of M; and
(e) drying the material of step (d).

19. (canceled)

20. The method of claim 18, further comprising:
(i) obtaining a [(R₂)ₜM²Hᵤ] material, where:
M² is a transition metal
R₂ is a hydrocarbon, a substituted hydrocarbon, or any combination thereof, preferably, an alkyl group, a substituted alkyl group, or any combination thereof; and
0≤t, 1≤u, and t+u is equal to the valence of M²; and
(ii) adding the material of step (i) to the compound of step (e).

21. The process of claim 1, wherein the catalyst is

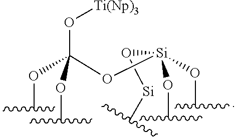

22. The process of claim 1, wherein the metal is Ta and the support is binuclear dehydroxylated SiO₂.
